(19) United States
(12) Patent Application Publication
(10) Pub. No.: US 2008/0052317 A1
(43) Pub. Date: Feb. 28, 2008

(54) MEDICATION DOSE CALCULATOR AND ASSOCIATED METHODS

(76) Inventors: Katharine R. Francis, Dunlap, IL (US); Diane M. Mathis, Springfield, IL (US); Gary Conkright, Naperville, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/928,636

(22) Filed: Oct. 30, 2007

Related U.S. Application Data
(62) Division of application No. 11/273,698, filed on Nov. 14, 2005.

(30) Foreign Application Priority Data
Aug. 27, 2002 (US) PCT/US02/27269

(51) Int. Cl. G06F 7/00

(52) U.S. Cl. 707/104.1

(57) ABSTRACT

A medication dose calculator and method for comparing an inputted, ordered medication dosage with a known medication dosage range in a database including an input device for inputting a desired drug name, indicating whether the drug is for a child or an adult, an amount of the drugs that are ordered, the body weight or body surface of the patient, and a computing mechanism for determining the dose of the drug to be delivered. The medication dose calculator provides warnings when the inputted amount of drug exceeds the dosage range limits or is incorrect. The medication dose calculator converts an inputted drug unit of measure into a desired unit of measure. In addition, various methods for receiving, recording, storing, transmitting, transferring, and editing information along with various processes utilizing the medication dose calculator are disclosed.

### CROSS REFERENCE TO RELATED APPLICATIONS

This application claims priority and benefit of U.S. Provisional Patent Application No. 60/315,145, filed on Aug. 27, 2001; U.S. Provisional Patent Application No. 60/335,684, filed Oct. 31, 2001; International Patent Application No. PCT/US02/27269, filed Aug. 27, 2002; and U.S. patent application Ser. No. 10/478,576, filed Nov. 24, 2003; and U.S. Utility patent application Ser. No. 11/273,698, filed Nov. 14, 2005; all of which are incorporated herein by reference. This application is a divisional application of U.S. patent application Ser. No. 11/273,698, filed on Nov. 14, 2005.

### TECHNICAL FIELD OF THE INVENTION

The present invention relates to medical computers and medical calculators and associated methods and, more specifically, an apparatus and method for calculating medication doses and for comparing an ordered, inputted dosage with a database having a recommended known medication dosage range and for providing cautions and warnings for the administration of a particular medication.

### DESCRIPTION OF THE RELATED ART

The terms “dose” and “dosage” are inconsistently used in the art. As used herein, dosage is an amount of medicine ordered by a qualified medical professional and is expressed in a quantity of measure (e.g., 10 mg), quantity of measure per weight (e.g., 10 mg/kg), quantity of measure per time (e.g., 10 mg/minute) or quantity of measure per weight and time (e.g., 10 mg/kg/min). Dose is a calculated volume required to deliver an ordered dosage from a larger volume available in a specified concentration. For example; if a medication is available in a concentration of 100 mg/1 ml, the volume required to deliver an order for 10 mg is the result of the computation of 10 mg÷100 mg×1 ml=0.1 ml. The dose in this case is 0.1 ml, the dosage (or order) is 10 mg.

The incidence of medication errors is a widely known problem in the medical industry. Most medications that are administered in the institutional setting are carefully checked for: 1) a correct dosage (amount of medicine ordered by a qualified medical professional) according to known drug dosage ranges; 2) a correct drug dose (calculated volume required to deliver an ordered dosage from a larger volume available in a specified concentration); and 3) cautions and warnings pertaining to the administration of that drug. These checks commonly occur in institutional pharmacies and are the standard of care in the industry. However, there are times when this system of checking medications in the pharmacy before dispensing the medication to the nursing unit is not feasible. For instance, in the neonatal intensive care unit, the nurse must calculate the doses for many drugs that are to be administered at the time of administration. In the surgical and cardiac intensive care setting, drug dosages are changed frequently and doses are often calculated by the nurse or physician at the patient's bedside. In the case of any medical emergency, such as cardio-respiratory arrest or shock, emergency medications are obtained from the emergency stock on hand in the patient care unit and calculated at the time of administration by the caregiver. In all cases, nurses and other health care givers are required to perform these calculations based on formulas committed to memory. Although the calculations are usually performed on a standard mathematical calculator, the potential for a high margin of error remains. First, there is a proper sequence of equations that are essential to obtaining the correct answer. Second, the equations often require conversion of various dimensional units (e.g., micrograms to milligrams, pounds to kilograms and so forth). These conversions must be calculated and then recorded or recalled for use in a later sequence of the equation. Third, knowledge of correct dosage ranges, cautions and warnings must be known to the medical professional for that person to safely administer the medication. The likelihood of all three of these factors being reliably drawn from the memory of the medical professional is understandably reduced under stressful situations such as a medical emergency or a sudden change in patient status.

There is a further need in the art for medication dosage range warning devices and dose calculators in medication administration situations remote from hospitals. These include field applications such as paramedics at an accident or disaster scene, visiting nurses, military field deployments, medical transportation such as ambulances and veterinary applications. Similarly, medical facilities having some support systems but still not remote from the hospital have a need for a portable medication dose calculators including without limitation satellite medical facilities, doctors' offices, hospices, clinics and the like.

A device that attempts to address a limited portion of the stated problems includes that disclosed in U.S. Pat. No. 6,167,412, which issued to Simons on Dec. 26, 2000. This handheld device prompts the user to complete drug dose and infusion calculations. This device includes a memory containing drug dosage information that is accessed by the user. This device does not link the input calculations with a drug database and does not provide a warning or a caution notification when an incorrect input has been entered. Although the device does complete the required calculation for the user, it does not provide the user with an on-screen, intuitive format for entering input data. The user of the device must rely on memory in order to recall the proper sequence of keypad compression to complete the various calculations. As a result, there is very little improvement over a standard calculator. The user's reliance on his or her memory is not significantly reduced and there is no system to alert the user of potential errors in the prescribed dosage or alert the user regarding potentially harmful drug, cautions and warnings if the user neglects to access the drug information database.

The present invention is directed to overcoming one or more of the problems set forth above.

### BRIEF SUMMARY OF THE INVENTION

In one aspect of this present invention, an improved medication dose calculator is disclosed. This medication dose calculator includes a user interface having an input device for inputting an ordered drug name, inputting an indication as to whether the drug is for a child or an adult, inputting an amount of the drug that is ordered, inputting the body weight or body surface area of the patient, inputting an amount of drug that is available in a specified concentration, and inputting the available volume associated with the amount of the available drug and a computing mechanism such as a processor for determining the appropriate dose of the drug that is to be delivered to the patient.

In another aspect of this present invention, a method for calculating medication doses is disclosed. This method includes inputting an ordered drug name, inputting an indication as to whether the drug is for a child or an adult, inputting an amount of the drug that is ordered, inputting the body weight or body surface area of the patient, inputting an amount of drug that is available in a specified concentration and inputting the available volume associated with the medication dose calculator and other external devices. These include maintenance of a medication database in the dose calculator and maintenance of a transactional record.

In still yet another aspect of the present invention, processes and systems that utilize the medication dose calculator are disclosed. These include data management, update, upload, download, synchronization and transfer systems.

These are merely illustrative examples of the innumerable aspects of this present invention and should not be deemed a limiting listing.

### BRIEF DESCRIPTION OF THE DRAWINGS

For a better understanding of the present invention, reference may be made to the accompanying drawings in which:

FIGS. 1A, 1B, 1C and 1D illustrate a schematic process diagram of the medication dose calculator associated with the present invention;

FIG. 2 illustrates an exemplary graphical input and output screen display of a medication dose calculator associated with the present invention;

FIG. 3 illustrates exemplary drop-down screen displays connected with the exemplary screen display shown in FIG. 2 associated with the medication dose calculator of the present invention;

FIG. 4 illustrates a top view of a sample keyboard and display screen associated with the medication dose calculator of the present invention;

FIG. 5 illustrates a block diagram of a basic functional schematic for the electronic components associated with the medication dose calculator of the present invention;

FIG. 6 illustrates a schematic process diagram of the special functions menu screen of the medication dose calculator;

FIG. 7 illustrates an alternative schematic process diagram of the medication dose calculator;

FIG. 8 illustrates a block diagram of the database memory and transactional memory associated with the medication dose calculator according to the present invention;

FIG. 9 illustrates a block diagram of a basic functional schematic for the electronic components and database and transactional memory associated with the medication dose calculator of the present invention;

FIG. 10 is an illustration of a system for utilizing the medication dose calculator, wherein the medication dose calculator utilizes a docking system for transferring and receiving data according to the present invention;

FIG. 11 is an illustration of the system shown in FIG. 10 along with a scanning system incorporated therein for inputting data into the present invention;

FIG. 12 is an illustration of the system shown in FIG. 11 but with a WiFi system replacing the docking system for transferring and receiving data according to the present invention;

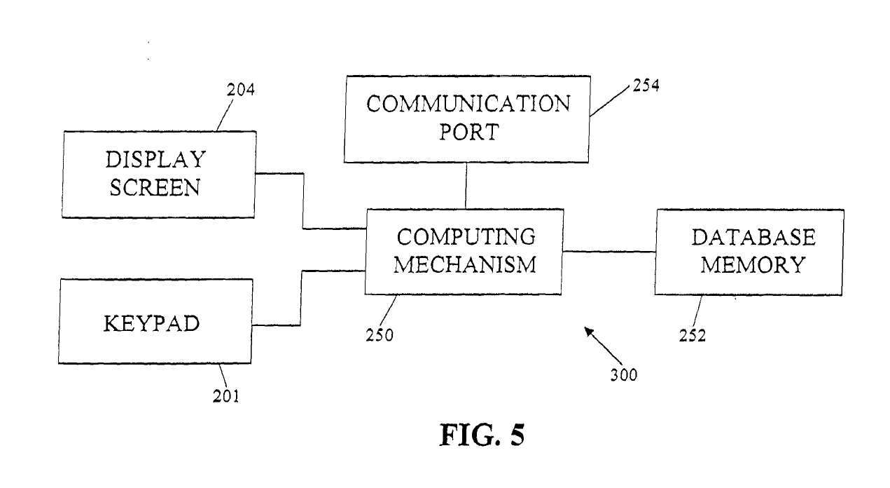

FIG. 5 illustrates a block diagram of a basic functional schematic for the electronic components associated with the medication dose calculator of the present invention;

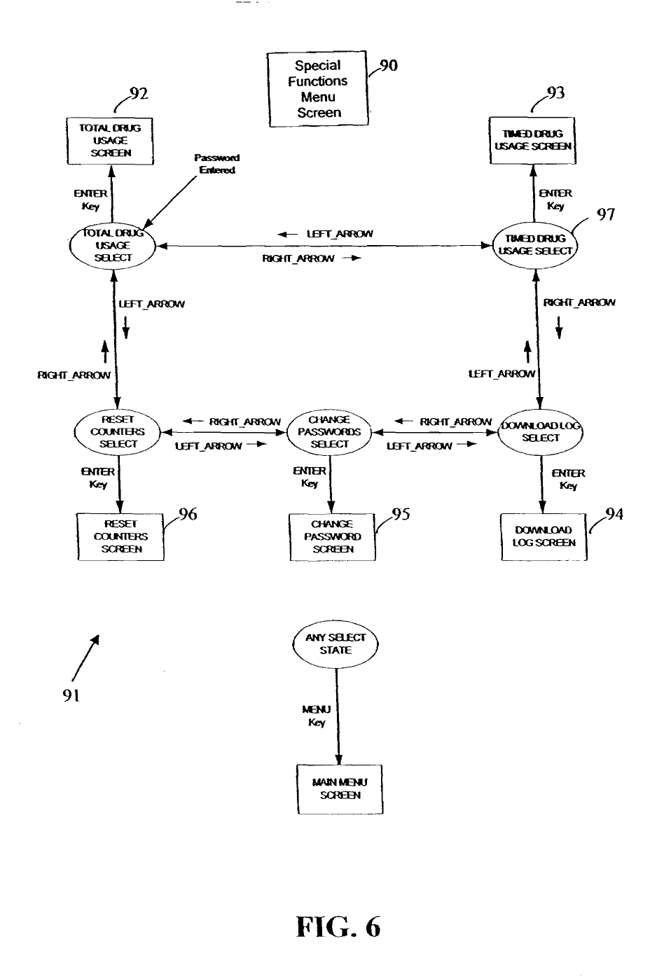

FIG. 6 illustrates a schematic process diagram of the special functions menu screen of the medication dose calculator;

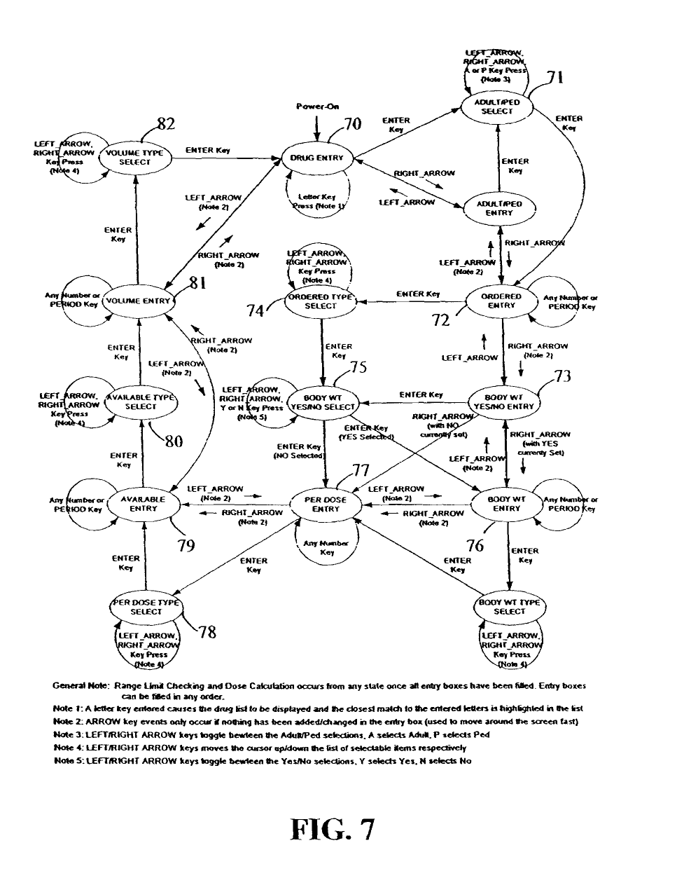

FIG. 7 illustrates an alternative schematic process diagram of the medication dose calculator;

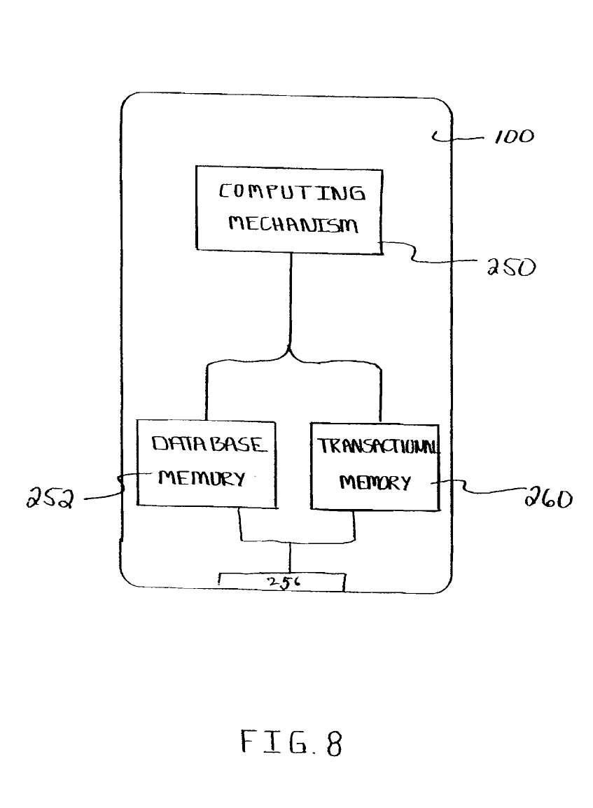

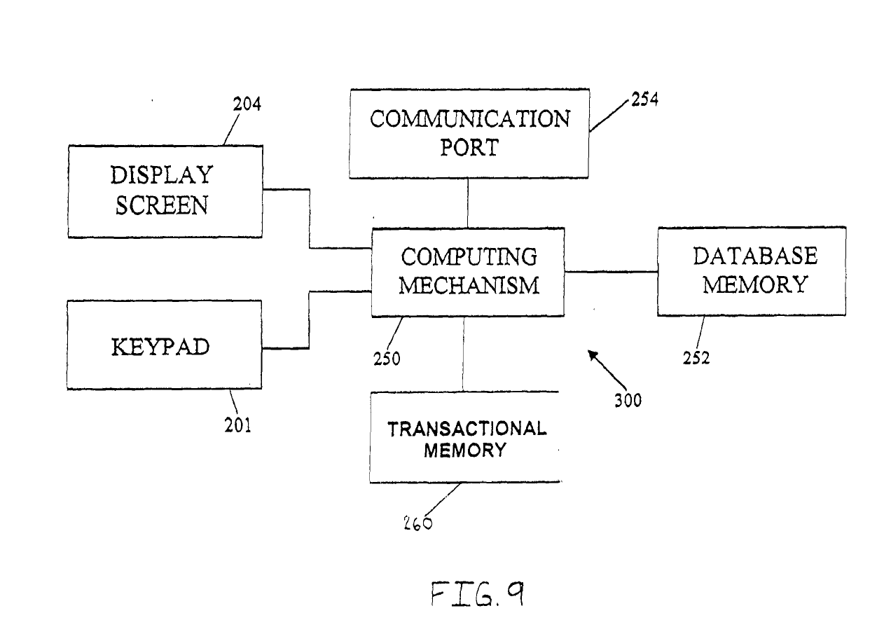

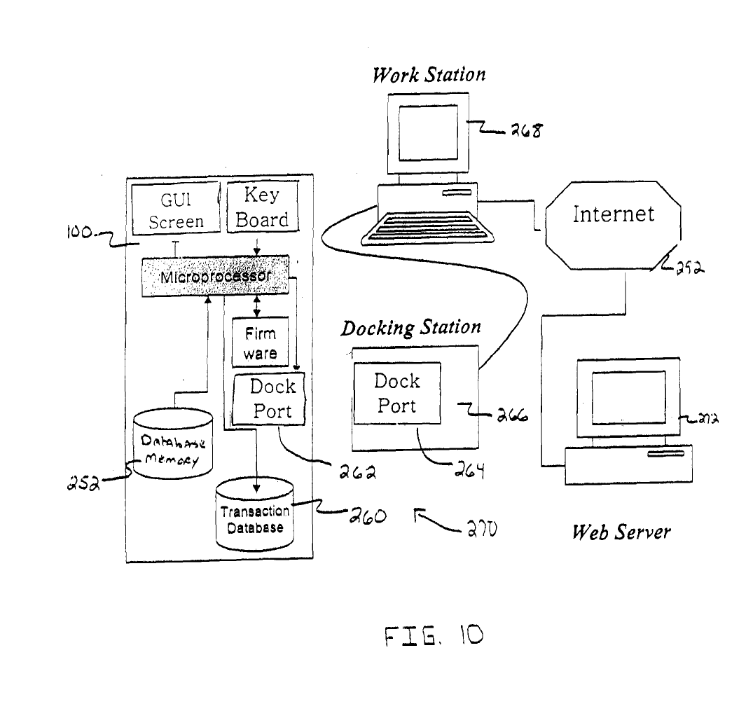

FIG. 8 illustrates a block diagram of the database memory and transactional memory associated with the medication dose calculator according to the present invention;

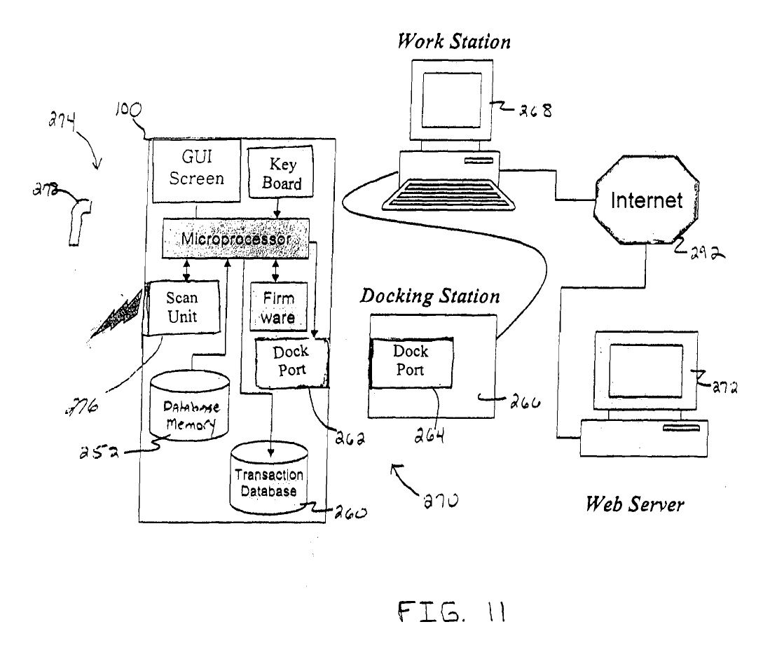

FIG. 9 illustrates a block diagram of a basic functional schematic for the electronic components and database and transactional memory associated with the medication dose calculator of the present invention;

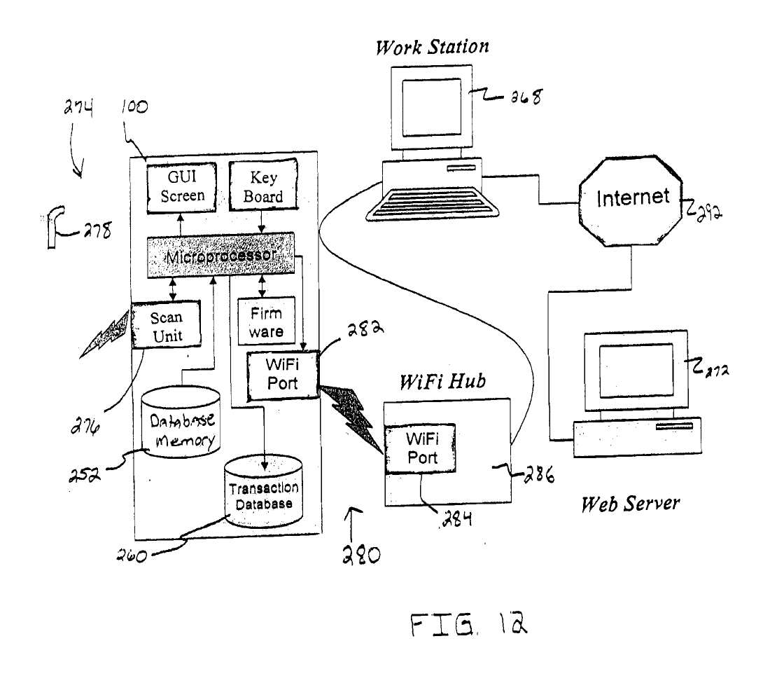

FIG. 10 is an illustration of a system for utilizing the medication dose calculator, wherein the medication dose calculator utilizes a docking system for transferring and receiving data according to the present invention;

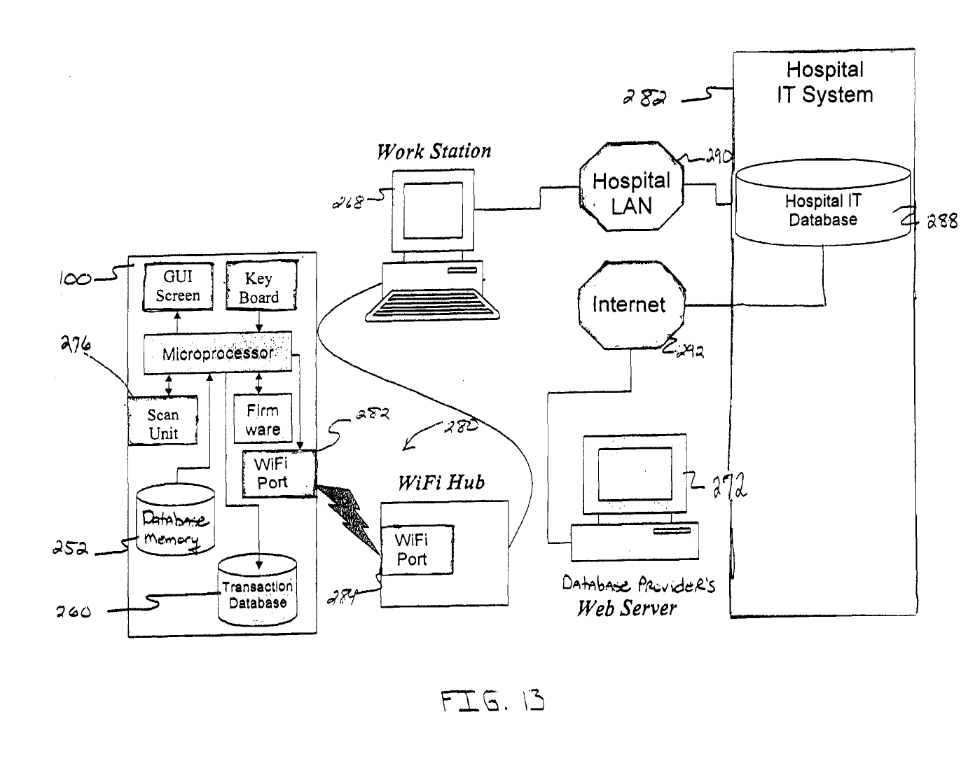

FIG. 11 is an illustration of the system shown in FIG. 10 along with a scanning system incorporated therein for inputting data into the present invention;

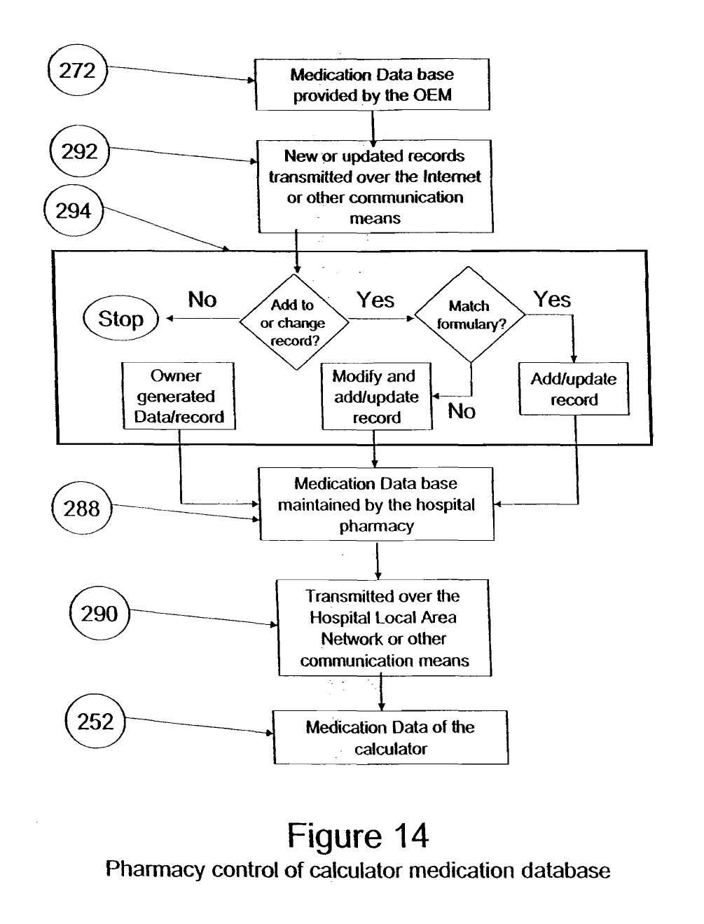

FIG. 12 is an illustration of the system shown in FIG. 11 but with a WiFi system replacing the docking system for transferring and receiving data according to the present invention;

FIG. 13 is an illustration of the systems shown in FIGS. 10-12 integrated with a hospital IT system; and

FIG. 14 is a diagram of a pharmacy control system incorporating a medication dose calculator which allows the hospital pharmacy to change the calculator medication database to match the hospital formulary.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. For example, the invention is not limited in scope to the particular type of industry application depicted in the figures, to hardware, firmware or software, to a particular type of software language, or to particular conventions regarding software designations. The calculator or computing mechanism referred to in this patent application can be performed with a single integrated circuit or can be the result of the functioning of an entire series of complex microprocessors. One method of communication to download the latest drug-related information associated with this invention is through a global computer network, e.g., Internet; however, there are numerous mechanisms for electronic communication that might suffice for this present invention.

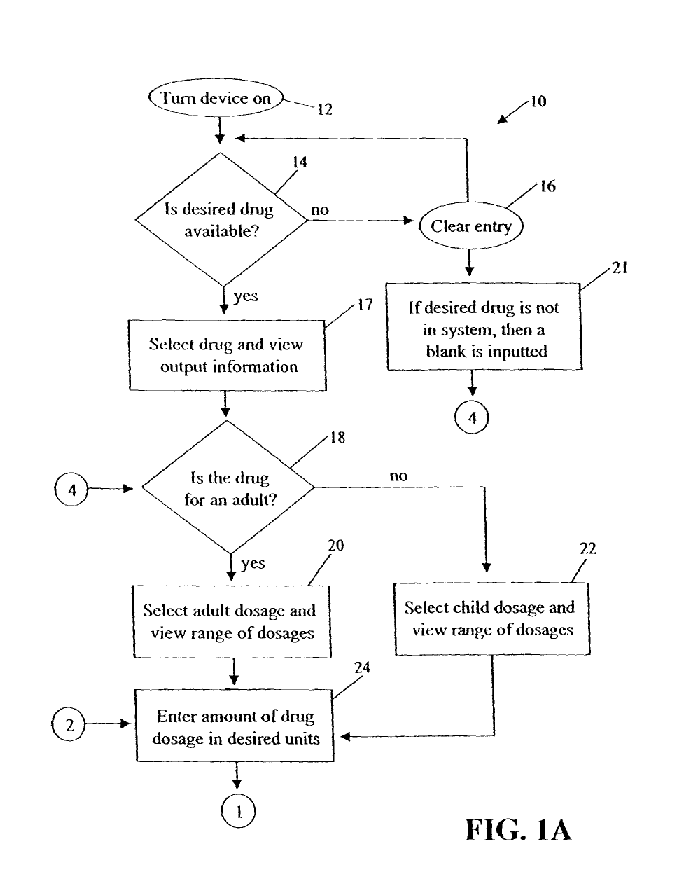

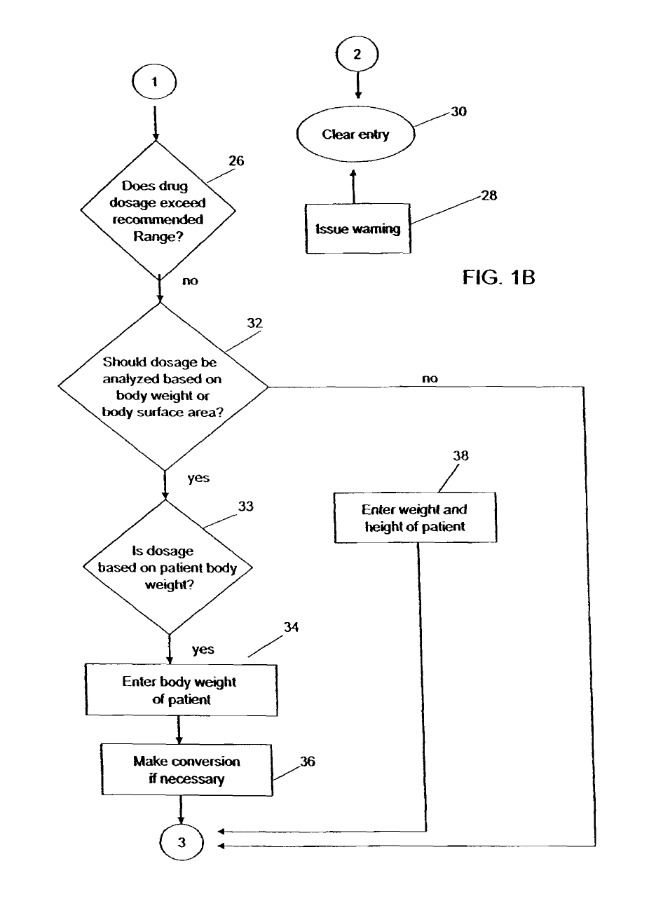

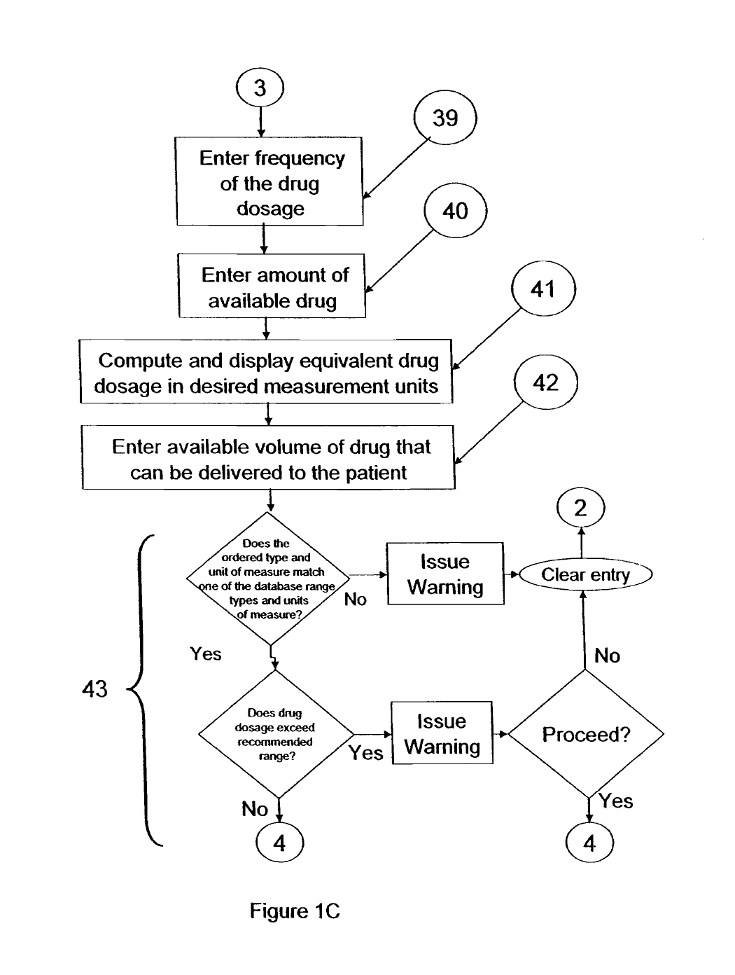

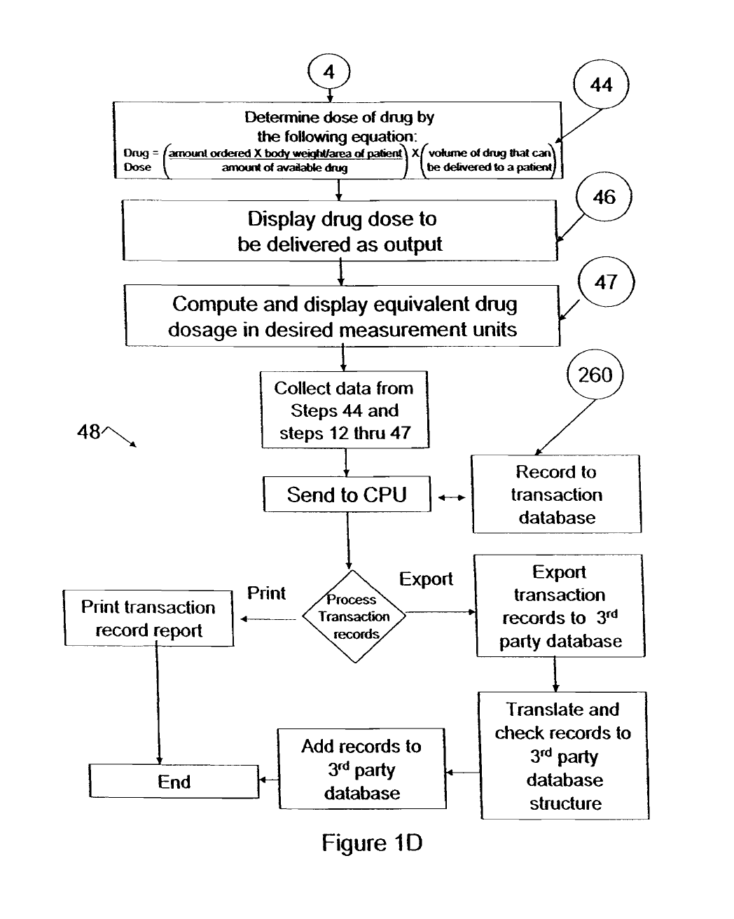

Referring now to the drawings, and initially to FIGS. 1A, 1B, 1C and 1D, which illustrate a flowchart of the medication dose calculator of the present invention, which is denoted generally by reference numeral 10. A programmer skilled in the art could utilize this flowchart to program any of a wide variety of electronic controllers/computers in a wide variety of programming languages. In the description of the flowchart in FIGS. 1A, 1B, 1C and 1D, the functional explanation marked with numerals in angle brackets, <nnn>, will refer to the flowchart blocks bearing that number. In the depicted embodiments the medication dose calculator is handheld, although other dose calculation devices, particularly if portable, are within the scope of the present invention.

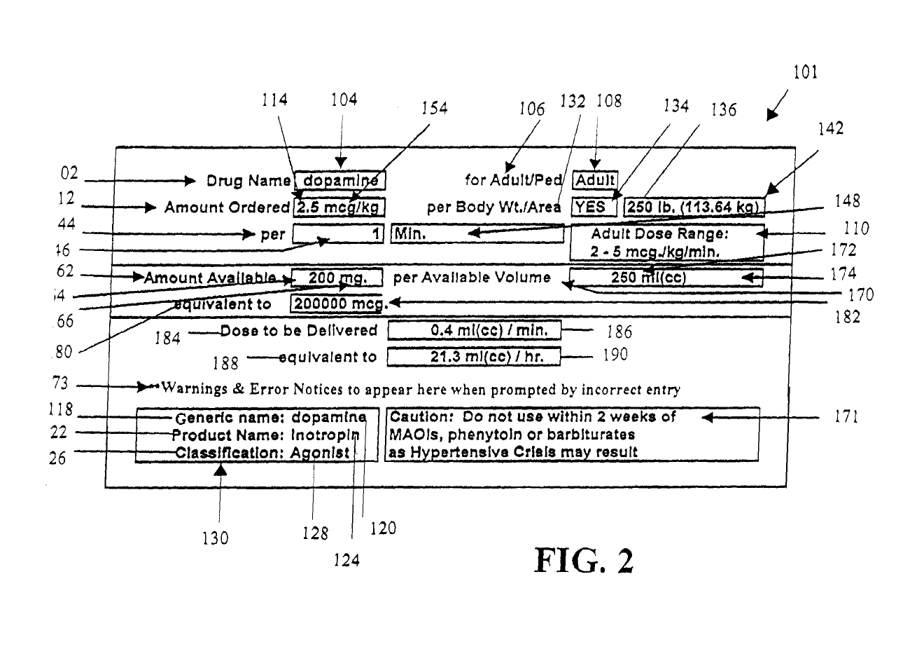

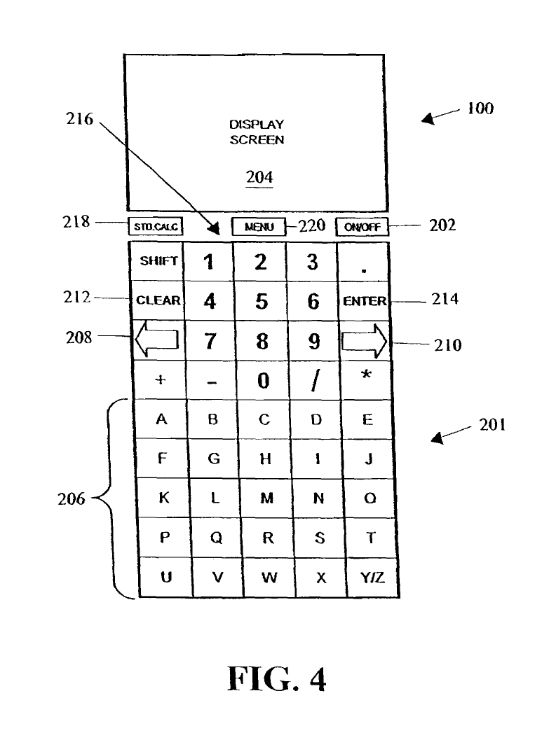

The first step in the process <12> is to activate or turn-on the medication dose calculator that is generally indicated by numeral 100 in FIG. 4. The on/off pushbutton 202, as shown in FIG. 4, performs this function. This activates a display screen 204, which displays the graphical user input and output screen that is generally indicated by numeral 101 in FIG. 2. Such a graphical user interface provides an intuitive input for the information that greatly reduces the need for the user to rely on his or her memory in performing the sequence of keypad operations on the medication dose calculator. The user interface may comprise a display screen combined with a keypad as depicted or a touch screen.

The display screen 204 is preferably a liquid crystal display; however, any electronic display can be employed such as a cathode ray tube (CRT), an electroluminescent display or a plasma display.

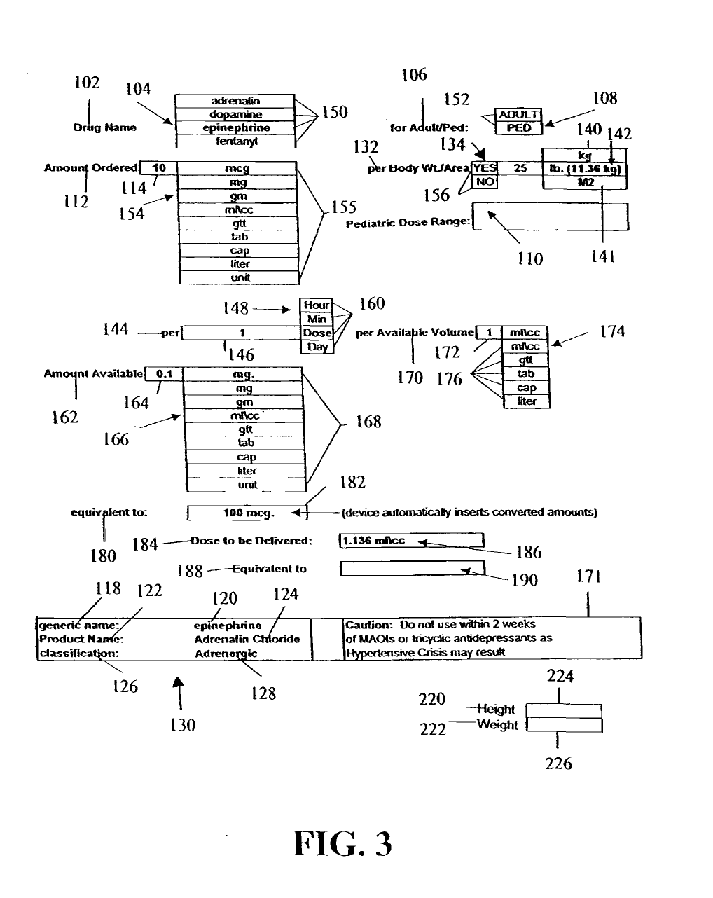

As shown in FIG. 2, there is a display output for the name of the desired drug, e.g., “drug name” label 102, that is adjacent to a drop-down entry input field for the desired drug name 104 that may be highlighted and include a flashing cursor. In the depicted embodiment, pressing one of the alphabetic keys 206 on the medication dose calculator 100, as shown on FIG. 4, will initiate the drop-down entry input field for the desired drug name 104 to reveal a selection of available drugs, as indicated by a drop-down selection 150 in FIG. 3.

The second step in the process <14>, as shown in FIG. 1A, is to determine if the desired drug is available. This involves scrolling among the drop-down selection 150, shown in FIG. 3, by utilizing either the left scroll arrow key 208 or the right scroll arrow key 210 on the medication dose calculator 100, as shown in FIG. 4.

If the desired drug is not available, the “clear entry” key 212 can be pushed, as shown in FIG. 4 and the second step in the process <14> can be repeated so that the user can again search for a desired drug. This “clear entry” procedure is indicated by the third step in the process <16>, as shown in FIG. 1A, which loops back to the second step in the process for inputting a desired drug <14>. If the desired drug is not in the system, then a blank can be inputted into the system through the enter key 214, as shown on FIG. 4, as indicated by the fourth step in the process <21>, as shown in FIG. 1A, which bypasses the next process step <17> and proceeds to process step <18>, as shown on FIG. 1A. In this specific instance, the tenth process step <26> of providing warnings if the drug dosage exceeds a recommend range is also bypassed.

The fifth step in the process <17>, as shown in FIG. 1A, is to select the desired drug and view associated output information. If the desired drug is located on the drop-down selection 150, as shown in FIG. 3, which may then be highlighted, the user can then press the “enter” key 214 for the medication dose calculator 100 shown in FIG. 4. There is an output for the generic name of the desired drug, e.g., “generic name” label 118, that is adjacent to an output for the generic name of the drug 120. There is also an output for the trademarked product name of the desired drug, e.g., “product name” label 122, that is adjacent to an output for the trademarked product name for the drug 124. Moreover, there is an output for the appropriate classification associated with the desired drug, e.g., “drug classification” label 126, that is adjacent to an output for the classification associated with the desired drug 128. These three labels 118, 122 and 126 and associated outputs 120, 124 and 128 appear in an output screen that is generally indicated by numeral 130 in FIGS. 2 and 3. There is also cautionary material and/or warnings associated with the selected drug that is displayed in output screen 171. This information is provided by the database memory 252 and provided to the computing mechanism 250 for display on the display screen 204, as shown in FIG. 5, which is a block diagram schematic that indicates the general electronic components and associated relationship for the medication dose calculator 100 that is generally indicated by numeral 300.

The sixth step in the process <18>, as shown in FIG. 1A, is to determine if the selected drug will be administered to a child or an adult. There is a output regarding whether the drug is to be administered to a child or an adult, e.g., adult/pediatric label 106, that is adjacent to an adult/pediatric drop-down entry input 108 regarding selection of whether it is a child or an adult, which may be highlighted and include a flashing cursor, as shown in FIG. 2, where a drop-down adult/pediatric selection 152 appears as shown in FIG. 3. The user can scroll between the two possible selections in the adult/pediatric drop-down selection 152, shown in FIG. 3, by utilizing either the left scroll arrow key 208 or the right scroll arrow key 210 on the medication dose calculator 100, as shown in FIG. 4. When the desired patient type, i.e., pediatric or adult, is located on the adult/pediatric drop-down selection 152, as shown in FIG. 3, the user can then press the “enter” key 214 on the medication dose calculator 100 shown on FIG. 4.

When this selection is made, the program will go to either the seventh process step <20> if the patient is an adult or to the eighth process step <22> if the patient is a child, as shown in FIG. 1A.

The proper range for either adult or pediatric dosages will appear as output 110, as shown in FIGS. 2 and 3. When the patient type is a child, the calculations may be carried out to the third decimal place for use in pediatric dose calculations, as opposed to adult calculations which are conventionally carried out two places.

The ninth step in the process <24>, as shown in FIG. 1A, is to input the desired dosage for the selected drug. As shown in FIG. 2, there is an output for the amount of drug ordered, e.g., “amount ordered” label 112, that is adjacent to a drug amount ordered input 114 that preferably is highlighted and includes a flashing cursor, as shown in FIG. 2. By pressing the numeric keys on the medication dose calculator 100, which keys are generally indicated at 216 on FIG. 4, the user can input the ordered amount of a drug to be dispensed. Adjacent to the drug amount ordered input 114 is a unit expression factor drop-down entry input 154 that may be highlighted and include a flashing cursor, as shown in FIG. 2, where a drop-down unit expression factor selection 155 appears as shown in FIG. 3. The user can scroll between the possible units of measurement in the unit expression factor selection 155, shown in FIG. 3, by utilizing either the left scroll arrow key 208 or the right scroll arrow key 210 on the medication dose calculator 100, as shown in FIG. 4. When the ordered unit of measurement is located on the drop-down unit expression factor selection 155, as shown in FIG. 3, the user can then press the “enter” key 214 on the medication dose calculator, as shown on FIG. 4.

The tenth step in the process <26>, as shown in FIG. 1B, may be to determine if the drug dosage exceeds the recommend range. If the quantity inputted though the drug amount ordered input 114 exceeds that for the selected patient type, i.e. adult or child, then a warning is issued as the eleventh process step <28>. This is done by comparing the inputted quantity data from the keypad 201 with range information from the database memory 252 through the computing mechanism 250 for the medication dose calculator 100, as shown in FIG. 5. This step could occur later in the process, either alternatively or additionally, if the warning is dependent on patient weight and/or frequency of drug administration.

Warnings are stored in the formulary or medication database or master medication database in a first memory. Warnings may be different, as for example between drugs, doses, pediatric or adult patients. They may appear as outside range warnings, or regardless of range status, as for example the drug interaction warning depicted in FIGS. 2 and 3.

This issued warning appears on an output screen 173, as shown in FIG. 2. If a warning is issued, then the twelfth process step <30> allows the user to clear the drug amount entry and returns the user to the ninth process step <24>, which allows the user to re-enter the desired drug dosage. However, a manual bypass of the system of warnings and outputted information that is available with a selected drug may be entered, <31> allowing a calculation of a dose to still be performed.

The thirteenth step in the process <32>, as shown in FIG. 1B, is to determine if the drug dosage should be analyzed based on either the body weight of the patient or the body surface area of the patient. There is, an output for either the body weight of the patient or the body surface area of the patient, e.g., per body wt./area label 132, that is adjacent to an body wt./area drop-down elective input 134 that may be highlighted and include a flashing cursor, as shown in FIG. 2, where a drop-down body wt./area selection 156 appears as shown in FIG. 3. The user can scroll between the two possible selections, i.e., yes or no, in the body wt./area drop-down selection 156, shown in FIG. 3, by utilizing either the left scroll arrow key 208 or the right scroll arrow key 210 for the medication dose calculator 100, as shown in FIG. 4.

The fourteenth step in the process <33>, as shown in FIG. 1B, is to determine if the drug dosage will be based on the patient's weight or the body surface area of the patient. There is a body weight/area data entry input 136, which is adjacent to the body wt./area drop-down selection input 134. By pressing the numeric keys 216 on the medication dose calculator 100, which are generally indicated on FIG. 4, the user can input the weight of the patient or the body surface area of the patient. Adjacent to the body weight/area data entry input 136 is a weight/body area drop-down selector 142 that allows the user to input the weight of the patient in, for example, pounds, kilograms or grams 140 or the body surface area of the patient in, for example, square meters 141. The user can scroll between the possible selections, i.e. the selections of the weight of the patient in pounds, kilograms or grams 140 or the body surface area of the patient in square meters 141 shown in FIG. 3, by utilizing either the left scroll arrow key 208 or the right scroll arrow key 210 on the medication dose calculator 100, as shown in FIG. 4.

If the dosage of the drug is based on body weight, then the numerical input in the body weight/area data entry input 136 is entered when the user presses the “enter” key 214 after previously selecting “yes” from the drop-down body wt./area selection 156 on the medication dose calculator 100 as shown on FIGS. 3 and 4, which is the fifteenth step in the process <34>, as shown in FIG. 1B.

The weight of the patient can be either in pounds (lbs.) or kilograms (kgs.), and appears in output 142 with converted amounts appearing adjacent to the selected weight expression unit. This conversion is the sixteenth step in the process <36>, as shown in FIG. 1B.

If the body surface area of the patient in square meters 141 is selected, a prompt for the height of the patient, 220, is output. An input for the height of the patient, e.g., patient height input field 224, appears, as well as an output prompt for the weight of the patient, 222, along with a patient weight input field 226, as shown in FIG. 3, through data input provided by the numeric keys 216 on the medication dose calculator 100, which are generally indicated in FIG. 4, which is the seventeenth process step <38> shown in FIG. 1B. This data is utilized by the processor 250 to either calculate using known surface area to height and weight ratios or by calling the information from storage in a look up table in the database memory 252 to arrive at the body area in square meters that is displayed in output 142.

The eighteenth step in the process <39>, as shown in FIG. 1C, is to enter the frequency for administering the drug dosage. There is an output for the frequency of providing the drug to the patient, e.g., “per” frequency label 144, that is adjacent to a frequency data input 146 that may be highlighted and include a flashing cursor, as shown in FIGS. 2 and 3. This frequency is input through a data input provided by the numeric keys 216, which are generally indicated in FIG. 4. Adjacent to the frequency data input 146 is the frequency expression factor drop-down elective input 148. The user can scroll among a number of possible frequency selections 160 including hour, minute, day and so forth, shown in FIG. 3, by utilizing either the left scroll arrow key 208 or the right scroll arrow key 210 on the medication dose calculator 100, as shown in FIG. 4. The processor 250 converts the data from the keypad 201 if input in either days or minutes into an hourly rate, as shown in FIG. 5.

When the ordered unit of frequency interval is selected through inputting the frequency data input 146 and the unit-expression factor selection 154, as shown in FIG.3, the user can then press the “enter” key 214 as shown on FIG. 4.

The nineteenth step in the process <40>, as shown in FIG. 1C, is for the user to enter the amount of the selected drug that is available in a specified concentration for the patient. The specified concentration may be that provided in standard packaging, or it may be an individualized, custom or otherwise adapted concentration created by medical personnel. There is an output to indicate the amount of the drug that is available in a specified concentration, e.g., “amount available” label 162, that is adjacent to a drug amount available input 164 that may be highlighted and include a flashing cursor, as shown in FIG. 2. By pressing the numeric keys 216 on the medication dose calculator 100, which are generally indicated on FIG. 4, the user can input the numeric amount of drug that is available. Adjacent to the drug amount available input 164 is a unit expression factor drop-down entry input 166 that may be highlighted and include a flashing cursor, as shown in FIG. 2 where a drop-down unit expression factor selection 168 appears as shown in FIG. 3. The user can scroll between the possible units of measurement in the unit expression factor selection 168, shown in FIG. 3, by utilizing either the left scroll arrow key 208 or the right scroll arrow key 210 on the medication dose calculator 100, as shown in FIG. 4. When the desired unit of measurement is highlighted on the drop-down unit expression factor selection list 168, as shown in FIG. 3, the user can then press the “enter” key 214 as shown on FIG. 4. Conversions to the appropriate unit of measurement will be automatically performed by the computing mechanism 250, as shown in FIG. 5.

In addition, the twentieth step in the process <41>, as shown in FIG. 1C, is to convert the amount available from the drug amount available input 164 into an equivalent number that is in a compatible unit of measurement to the unit of measurement that is entered in the amount ordered field. There is an output for an equivalent amount of the drug in a preferred unit of measurement, e.g., “equivalent to” label 180, that is adjacent to a converted drug amount output 182. Conversions to the compatible unit of measurement will be automatically performed by the computing mechanism 250 and displayed on the display screen 204 for the medication dose calculator 100, as shown in FIG. 5. If incompatible unit expression factors are entered, the medication dose calculator 100 will not perform the calculation until the error is fixed.

The twenty-first step in the process <42>, as shown in FIG. 1C, is to enter the available volume associated with the numeric amount available of the drug on hand that can be delivered to the patient. There is an output for indicating the volume associated with the amount of available drug in a specified concentration, e.g., “per available volume” label 170 that is adjacent to a volume of the available drug input 172 that may be highlighted and include a flashing cursor, as shown in FIG. 2. By pressing the numeric keys 216 on the medication dose calculator 100, which are generally indicated on FIG. 4, the user can input the available volume for the amount of the selected drug that is available. Adjacent to the volume of the available drug input 172 is a unit expression factor drop-down entry input 174 that may be highlighted and include a flashing cursor, as shown in FIG. 2 where a drop-down unit expression factor selection 176 appears as shown in FIG. 3. The user can scroll between the possible units of measurement in the unit expression factor selection 176, shown in FIG. 3, by utilizing either the left scroll arrow key 208 or the right scroll arrow key 210 on the medication dose calculator 100, as shown in FIG. 4. When the desired unit of measurement is highlighted on the drop-down unit expression factor selection 176, as shown in FIG. 3, the user can then press the “enter” key 214 on the portable medication dose calculator 100 as shown on FIG. 4. Conversions to the appropriate unit of measurement will be automatically performed by the computing mechanism 250, as shown in FIG. 5.

In the depicted embodiment two safety checks may be executed. Any number of safety checks are within the scope of the present invention. At process step 43 the database is rechecked after the calculations and data entered in steps 32 through 42. At this point, after step 42, the dosage ordered status is checked to see if the ordered type and unit of measure match a corresponding range of type and units of measure in the database. If they do not match a warning is issued, with a prompt to clear the entry and reenter the appropriate data. If the dosage ordered is within the corresponding range of types and units of measure, the actual dosage is rechecked against the corresponding dosage range. If it is within range, the dose is calculated, as described below and on FIG. 1D. If the range is exceeded, a warning is issued. Thereafter an override step is provided wherein an override can be declined, the entry cleared and the data reentered, or the warning may be manually overridden in order to proceed to a dose calculation.

The twenty-second step in the process <44>, as shown in FIG. 1D, is to compute the dose of the drug to be administered. This includes multiplying the amount of the drug that is ordered from the drug amount ordered input 114 times the body weight or the body surface area from the body weight/area data entry input 136. This product is then divided by the amount of drug that is available from the drug amount available input 164. This result is then multiplied by the volume of the drug from the amount available that can be administered to the patient from the volume of the available drug input 172. This result is the dose of the drug to be delivered to the patient. This output may be expected in less than two seconds.

The twenty-third step in the process <46>, as shown in FIG. 1D, is to output the dose of the drug computed in the previous process step <44>. There is an output to indicate the drug dose to be delivered to the patient, e.g., “dose to be delivered” label 184 that is adjacent to a delivered drug dose output 186.

In addition, the twenty-fourth step in the process <47>, as shown in FIG. 1D, is to convert the drug dosage from the drug amount available input 164 into an equivalent number in a desired unit of measurement for drug administration frequency. This is only triggered when the frequency selection 160 of the drug dosage is determined on a “per minute”, a “per hour” or a “per day” basis and not when the “per dose” input is selected. As shown in FIGS. 2 and 3, there is an output for this for the drug dose in the preferred unit of measurement, e.g., “equivalent to” label 188 that is adjacent to a converted drug dose to be delivered in a preferred measurement unit 190. Conversions to the desired unit of measurement for the medication dose calculator 100 will be automatically performed by the computing mechanism 250 and displayed on the display screen 204, as shown in FIG. 5.

In addition, the twenty-fifth step in process as shown in FIG. 1D, is to store the transaction data into the transaction database 260. All inputs, whether manually entered or otherwise, and all outputs from the calculator, including but not limited to dose and any warnings are stored along with time and day and the versions of the database and firmware that was used in performing the volume calculation and determining its appropriateness. These records can then be sent to another device for printing, or can be sent to 3^{rd} party database, such as an electronic medical records system.

In the depicted embodiment, process step 48 generally is to record a transactional record. Entries into RAM, including but not limited to data entry or keystrokes by a user, prompts or messages generated by the medication dose calculator, warnings, overrides and the like are all saved to memory 260. Process step 48 will save all transactions to memory 260 upon completion of the ultimate display of the drug dose in desired measurement units, steps 46 and 47. Each transaction is saved either as it is entered, or through temporary storage in short term memory in RAM followed by transfer to memory 260. Thereafter, as depicted in FIG. 1D, the transactional database may be recalled by the CPU so that the transactional records in it may be processed. Processing may either be to print, whereupon the data is transferred to a printer, or to transfer for export outside the medication dose calculator, which may in turn involve a step of translating the records to a third party database structure, after which they are stored in the third party database.

The user then administers the appropriate amount of drugs to the patient. Throughout all of these steps and functions above, a user will be making inputs to the medication dose calculator 100, the medication dose calculator will be providing outputs and menus, and database information will be downloaded to the medication dose calculator 100. All of these inputs, outputs, menus, downloads, and actions will be recorded or stored in the transactional database 260.

Referring now to FIG. 4, there is a calculator pushbutton key 218, which allows the medication dose calculator 100 to function as a standard calculator as well as a menu pushbutton key 220 that allows the user to access other functions of the medication dose calculator 100. Although the description herein describes the user making inputs and selections via various input means 201, 202, 206, 208, 210, 212, 214, 216, 218, 220 by depressing, pressing, or pushing a key or pushbutton, it should be noted that there are various devices known in the art for entering inputs and selections that may be substituted in the present invention. For examples, and without limitation the medication dose calculator 100 may be configured to receive inputs or selections from the user via a touch screen, voice activation technology, bar code technology, and various other data input mechanisms. Each of these technologies are within the scope of the present invention.

In the depicted embodiment, there is a device to update the database memory 252 as shown in FIG. 5. For example, a communication port 254 could be connected to the computing mechanism 250 for updating the database memory 252. An example of how this can be accomplished is described in U.S. Pat. No. 6,266,539, which issued to Pardo on Jul. 24, 2001, which is incorporated herein by reference. This is a docking arrangement that connects the computing mechanism 250 to the Internet via a telephone communication line.

Another mechanism can include a PCMCIA card for receiving a chip card such as that disclosed in U.S. Pat. No. 6,069,795, which issued to Klatt et al. on May 30, 2000, which is incorporated herein by reference. The chip card could have a static read only memory (ROM) that includes the database memory 252.

Infrared sensors can also be utilized to update the database memory 252. An example of this type of technology can be found in U.S. Pat. No. 6,025,942, which issued to Scifres on Feb. 15, 2000, which is incorporated herein by reference.

These are just some of the illustrative, but nonlimiting, examples of the many types of technology that can achieve this function of updating the database memory 252.

Referring now to FIG. 6, a hidden special functions password entry screen 90 is displayed in the display screen 204. The special functions screen 90 provides the user with a single box to enter a password. The password may be between one and ten characters in length. The characters being entered by the user is not displayed, rather a ‘#’ symbol is displayed instead for each character entered. When the password is entered and the ENTER key is pressed, the password is compared to the special functions password and the special function master password. If either matches, the password screen is closed and the special functions screen 90 menu is displayed. If there is no match, a message indicating password incorrect is displayed and the password entry box is cleared so that the user can try again. Initially, there is no limit to the number of failed attempts, but this feature is easily added by one skilled in the art. A single CLEAR key press clears all characters currently entered in the password entry box. Selection of the MENU key at any point shall close the password screen and return to the Menu Options screen.

A special functions menu options screen 91 has five options for selection as follows: a total drug usage option 92; a timed drug usage option 93; a download warning/event log option 94; a change passwords option 95; and a reset usage counters option 96. The left and right arrows keys enable the user to scroll up and down the options list, and the current cursor position shall be highlighted with a dark background and white text. Pressing the ENTER key will select the currently highlighted option and display the appropriate screen. Selection of the MENU key at any point will close the special functions Menu Options screen 91 and return the user to the main menu options screen.

The total drug usage option 92 screen displays the current values for the following counters: 1) total usage; 2) total number of decimal entries in the digital display screen 204; 3) individual drug usage; 4) total number of outside of range warning occurrences; 5) total number of outside of range warning occurrences that were overridden by the user; 6) total number of outside of range warning occurrences that were corrected by the user; 7) total number of no range check warning occurrences; 8) total number of no range check warning occurrences that were overridden by the user; 9) total number of no range check warning occurrences that were corrected by the user; 10) total number of conversion error occurrences; and 11) total number of conversion error occurrences that were corrected by the user.

Individual drug usage totals are selectable by selecting the drug from a list of available drugs. To select a drug, the user starts typing in the drug name in the drug selection 70 box. Upon entry of the first letter of the drug, the display screen 204 displays a list of all available drugs and will automatically jump to and highlight the first drug listed which starts with the letter entered. As the user enters more letters, the display screen 204 will automatically highlight the closest match. When the user presses the ENTER key, the currently highlighted drug in the list will be selected, and the drug list will close. However, after the entry of one or more letters into the drug selection 70 box but before the ENTER key is pressed, the user is able to move into the drug list by pressing the left or right arrow keys. When this occurs, the left and right arrow keys shall then move the cursor highlight up and down through the drug list respectively. At any point, pressing the ENTER key shall select the currently highlighted drug as the active drug, and close the drug list. The available drug list is displayed in alphabetical order.

When a drug has been selected, its total usage value is read from the drug database file and displayed adjacent to the selected drug name. Selection of the MENU key at any point will close the total drug usage screen 92 and return the user to the special functions menu screen 90.

The timed drug usage screen 93 will display the current values for the following shift counters: 1) number of outside of range warning occurrences in the shift period; 2) number of outside of range warning occurrences that were overridden by the user in the shift period; 3) number of outside of range warning occurrences that were corrected by the user in the shift period; 4) number of no range check warning occurrences in the shift period; 5) number of no range check warning occurrences that were overridden by the user in the shift period; 6) number of no range check warning occurrences that were corrected by the user in the shift period; 7) number of conversion error occurrences in the shift period; and 8) number of conversion error occurrences that were corrected by the user in the shift period.

A timed drug usage screen 97 displays the Shift Time Period, and the date/time that the current shift is due to end, and a option to view the counts for the current shift or each of the previous 3 shifts. The user is able to set the Shift Time Period to between one and twenty-four hours in one hour increments by typing in the value required and then pressing the ENTER key to set this value entered. When the Shift Time Period is changed, a confirmation required message will be displayed informing the user that changing the Shift Time Period will cause all previous shift data to be lost. The message shall provide the user with a yes/no option to continue and change the time period or to cancel the operation. If yes is selected (confirm change to time period), all shift counters shall be reset and the new current shift shall commence from the current time. If no is selected, the message shall be closed and the user returned to the timed drug usage screen 97 with no action taken. From the Shift Time Period entry box, the left or right arrow key when pressed will activate a selection list to display shift period counters. When the list is active, the left and right arrow keys shall then move the cursor up/down the list items. Pressing the ENTER key selects the shift period counters to display. At any point, if the ‘+’ key is pressed a sub-screen shall be displayed listing the last four entries in the warning/event log. When the warning/event log display sub-screen is active, the user is able to close it and return to the timed drug usage screen 93 by pressing the ENTER or CLEAR key. Selection of the MENU key at any point will close the timed drug usage screen 97 and return the user to the special functions menu screen 90.

The selection of the download warning/event log option will cause the medication dose calculator 100 to copy the warning/event log to a text file on a PCMCIA card. Embodiments of the methods, apparatuses, and systems for storing these warnings and event logs and transferring the stored logs or data to another medium are described in detail below. It is important to note that although a PCMCIA card is mentioned above, those having ordinary skill in the art may substitute other technologies for copying, receiving, storing, and transferring logs or data without departing from the scope of the present invention. When the file copy has finished, a download complete message is displayed informing the user. If the medication dose calculator 100 is unable to copy the log to a PCMCIA (i.e. no card inserted), a message is displayed informing the user. Once again, the updating of the database can be updated by other means as explained above. When the user acknowledges whichever message is displayed, the message is closed and the user returned to the special functions menu screen 90.

The change passwords screen 95 provides the user with the options of changing the special function menu 90 entry password and the reset counters confirmation password. The left and right arrow keys will toggle between the two new password entry boxes. The ENTER key shall indicate the completion of the entry of a new password if the password entry box contains one to ten characters. When a valid new password has been entered, the user is prompted with a sub-screen to enter the current password as confirmation that they wish to change to the new password. When a confirmation password has been entered (followed by ENTER), the medication dose calculator 100 checks the confirmation password against the stored current password and if they match replaces the stored password when the new password entered. If the confirmation password does not match the stored current password, the display screen 204 will display an incorrect password message and clear the entry box ready for the user to try again. Initially, there is no limit to the number of failed attempts the user is allowed to make. At any point, selection of the MENU key cancels the action and returns the user to the special functions menu 10 screen 90.

Upon selection of the reset counters option 96, the medication dose calculator 100 prompts the user to enter a reset counters confirmation password. When a confirmation password has been entered (following by ENTER key), the medication dose calculator 100 checks the confirmation password entered against the stored current password and if they match all total and timed counters are set to zero. Once this is complete, a message is displayed indicating that all counters have been successfully reset. When the user acknowledges this message (ENTER key), the message is closed, and the user returned to the special functions menu screen 90. If the confirmation password does not match the current stored reset counters password, the display screen 204 displays an incorrect password message and clears the entry box ready for the user to try again. Initially, there is no limit to the number of failed attempts the user is allowed to make. At any point, selection of the MENU key cancels the action and returns the user to the special functions menu screen 90.

Referring now to FIG. 7, the display screen 204 of the medication dose calculator 100 displays various functions. The display screen 204 has a default screen on start-up. The display screen 204 has the following functional options: drug selection 70; adult or pediatric selection 71; ordered type entry 72; overall ordered type selection 74 of either mcg, mg, gm, units or mEq, with mg as default; body weight/area—yes or no selection 73; body weight/area value entry 75 (but only when yes selected for 73); body weight/area type selection 76 of either lb, kg, gm or square meters, with lb as default (but only when yes selected 73); dosage/time quantity 77 with default value of 1; dosage/time type selection 78 of either per dose, min, hour or day, with dose as default; amount available quantity 79; amount available type selection 80 of either mcg, mg, gm, units or mEq, with mg as default; available volume quantity 81; and available volume type selection 82 of either liter, cc, tab or gtt, with cc as default. When all of the required parameters have been entered by the user, the application will perform a dose calculation. The required parameters are ordered type entry 72, overall ordered type selection 74 of either mcg, mg, gm, units or mEq, with mg as default, body weight/area value entry 75 (but only when yes selected for 73); body weight/area type selection 76 of either lb, kg, gm or square meters, with lb as default (but only when yes selected 73); dosage/time quantity 77 with default value of 1; amount available quantity 79; amount available type selection 80 of either mcg, mg, gm, units or mEq, with mg as default; available volume quantity 81; and available volume type selection 82 of either liter, cc, tab or gtt, with cc as default. The data parameters can be entered in any order. For the dose calculation, the medication dose calculator 100 uses the following pharmaceutical formula for calculating the dose to deliver based on the data parameters entered by the user:
Dose=(Total Amount Ordered/Amount Available)*Volume

where the Total Amount Ordered can be equal to either:

a) Amount Ordered

b) Amount Ordered*(Body Weight or Body Area of Patient)

c) Amount Ordered*((Body Weight in kg or Body Area in M²)/Time)

The dose calculation is to be ‘circular,’ meaning that once all required parameters have been entered, the changing of any one parameter will cause a re-calculation of the dose to deliver and the displaying of any new warning message if appropriate. A drug does not have to be selected in order to perform a dose calculation. During dose calculation, if the overall ordered type selected 74 does not match the amount available type selected 80, the medication dose calculator 100 displays a conversion error message and the ordered type entry 72 box becomes the active control. (Note: any combination of mcg, mg and gm is considered a match). The drug database file contains up to three dosage ranges for each drug, each range with a different ordered type (e.g. 1-4 mg/dose, 20-50 mcg/kg/dose and 5-7 mcg/kg/min). During dose calculation, the overall ordered type 74 is first matched against the database range types. If no match of the overall ordered type 74 against the database range type can be found, the medication dose calculator 100 displays a range check warning message indicating the problem. The message also provides the user with a yes/no option of continuing with no range checking or changing the ordered type 74.

If yes is selected (to continue with no range checking), the calculated dose is displayed and the warning LED's set to a flashing mode to indicate that the ordered amount has not been checked against the recommended ranges. If no is selected, the calculated dose is discarded and the ordered type entry 72 box becomes the active control.

When the ordered type 72 matches one of the database range types, the total ordered amount is checked against the range values. If the total ordered amount is either higher or lower than the range values, the display screen 204 displays a dosage warning message. The message provides the user with a yes/no option of continuing with the current total amount ordered or changing the amount ordered. If yes is selected (to continue with current amount ordered), the calculated dose is displayed and the warning LED's set to a flashing mode to indicate the total amount ordered is outside the recommended drug range. If no is selected, the calculated dose shall be discarded and the ordered entry 72 box becomes the active control. There are two exceptions to this when performing the ordered type/database range type matching. The first exception occurs if the user has entered a body weight/area value 75, but the database range type does not have /kg but otherwise they match (e.g. ordered mg/kg/dose but database has mg/dose). In this case, a flag is set and if no match is then subsequently found the medication dose calculator 100 calculates the total amount ordered (by multiplying the amount ordered by the body weight in kg) and then performs a range check as though the ordered type was in mg/dose. The second exception occurs if the ordered type does not have a body weight/area value 75 but the database range type does but otherwise they match (e.g. ordered mg/dose but database has mg/kg/dose). In this case, another flag is set and if no match is subsequently found, a warning message is displayed informing the user that no range checking could be performed but could be if the user entered the patients estimated body weight. The message also provides the user with a yes/no option of continuing without range checking or to enter the patients estimated body weight. If yes is selected (to continue without range checking), the calculated dose is displayed and the warning LED's set to flashing to indicate that the ordered amount has not been check against recommended ranges. If no is selected, the calculated dose is discarded and the body weight/area yes/no option 73 is automatically set to yes and the body weight/area value entry 75 box then becomes the active control.

The total amount ordered (Amount Ordered*Body Weight in kg) is displayed when the user has selected a body weight/area value in the calculation. If the ordered quantity is over a time period (i.e. min, hour or day), then when the dose is successfully calculated the medication dose calculator 100 also calculates expanded rates to include: i/cc/min; ii/cc/hour; iii/dose/min; iv/dose/hour; v/dose/kg/min; and vi/dose/kg/min. If the-user has entered no body weight, the last two rates shall show ‘NA’.

The expanded rates are displayed on a separate sub-screen, which appear when the user presses the ‘*’ key. Once the sub-screen is active, the ‘ENTER’ key clears it. When expanded rates are available and there is room on the display screen 204, a message is displayed indicating that to view the expanded rates the user must press the ‘*’ key. Only the ENTER key submits a new parameter for validation. If the value entered is valid, the medication dose calculator 100 either calculates the dose to deliver (only if all other required parameters have been entered) or moves to the next parameter entry/type selection. Dose calculations only occur after a new quantity value and its associated type have been entered. The left and right arrow keys are used to scroll quickly around the display screen 204 without causing any data entry or dose re-calculations to occur. The current cursor position (active control) is indicated by a dark background with white text. When scrolling with the left and right arrow keys, the adult/pediatric and yes/no lists are not displayed. Type selection lists are displayed when their associated entry box is scrolled upon but the lists themselves are not part of the scroll order. Accordingly, a user may enter the drug selection 70; adult or pediatric selection 71; ordered type entry 72; ordered type selection 74 of either mcg, mg, gm, units or mEq, with mg as default; body weight/area—yes or no selection 73; body weight/area value entry 75 (but only when yes selected for 73); body weight/area type selection 76 of either lb, kg, gm or square meters, with lb as default (but only when yes selected 73); dosage/time quantity 77 with default value of 1; dosage/time type selection 78 of either per dose, min, hour or day, with dose as default; amount available quantity 79; amount available type selection 80 of either mcg, mg, gm, units or mEq, with mg as default; available volume quantity 81; and available volume type selection 82 of either liter, cc, tab or gtt, with cc as default items, the left and right arrow scroll order is the drug selection 70; adult or pediatric selection 71; ordered type entry 72, body weight/area—yes or no selection 73; body weight/area value entry 75 (but only if option body weight/area—yes or no selection 73 is set to yes); dosage/time quantity 77; amount available quantity 79 and available volume quantity 81. While scrolling adult/pediatric and yes/no, a selection is achieved by scrolling onto the current value and pressing the ENTER key. The list will then appear with the non-active value selected as default.

When a list selection is the active control, the left and right arrow keys move the selection cursor up and down the list, respectively. The list will only be exited when the ENTER key is pressed, upon which the highlighted list item is selected and becomes the active value. All list selection controls wrap-around from top to bottom and bottom to top. When a drug is selected, the data for that drug is read from the drug database file and populates the drug information sub-screen which may be displayed at any time in the display screen 204 by the user pressing the ‘+’ key. When a drug is selected, the first dosage range for this drug from the database is displayed at the top of the display screen 204. If no dosage range exists for the selected drug, a message indicates that no dosage range is available for this drug. The drug information sub-screen when active is only cleared by the pressing of the ENTER or CLEAR key once. Upon returning to the display screen 204, the control that was active prior to the ‘+’ key being pressed regains active control. The application stores the last entered amount available and available volume values within the record for the currently selected drug in the drug database file. If no drug is selected, these value will not be stored. When the user re-selects a drug that has saved amount available and available volume values, the application displays a message informing the user of the stored value and offering the yes/no option of using these values or entering new values. If yes is selected (use stored values), the amount available quantity 79 entry box and available volume quantity 81 entry box is automatically populated with the stored value. However, this message will only appear when the user has just finished selection of a dosage/time type selection 78. When the user enters a body weight in lb or grams, the application converts the entered value into kg and displays this value adjacent to the entered value.

Once a dose has been calculated and a warning message issued, the same warning message will only be displayed again if the amount ordered value is changed or the dose calculated is different than previous. Upon re-entry to the display screen 204 (after the user has been in the Calculator or Menu screens), the active control is the same control that was active immediately prior to the display screen 204 being exited. To select a drug the user starts typing in the drug name in the drug selection 70 box. Upon entry of the first letter of the drug, the medication dose calculator 100 displays a list of all available drugs and automatically jumps to and highlights the first drug listed which starts with the letter entered. As the user enters more letters, the medication dose calculator 100 will automatically highlight the closest match on the list. When the user presses the ENTER key, the currently highlighted drug in the list is selected and becomes the active drug, the drug list closes and the adult/pediatric list becomes the next active control. At this point, the information for this drug reads from the database file and formatted ready for display and the ‘*’ key option becomes active. After the entry of one or more letters into the drug selection 70 box but before the ENTER key is pressed, the user is able to move into the drug list by pressing the left or right arrow keys. When this occurs, the left and right arrow keys then move the cursor highlight up and down through the drug list, respectively. At any point, pressing the ENTER key selects the currently highlighted drug as the active drug, closes the drug list and the adult/pediatric list becomes the next active control. At this point, the information for this drug reads from the database file and formatted ready for display and the ‘*’ key option becomes active. The available drug list is displayed in alphabetical order. Decimal values are valid for all quantity parameters except the dosage/time parameter, which are an integer value. All dose calculations with the pediatric selection are displayed-to three decimal places. All dose calculations with the adult selection are displayed to two decimal places. A single CLEAR key press clears any value entered in the currently active control if the control is one of the entry boxes. If the CLEAR key is pressed twice with the second key press within approximately one second of the first key press, all entered values are cleared and the screen reverts to its default state. Selection of the MENU key at any point displays the Menu Options screen. Selection of the MATH CALC key at any point displays the basic calculator screen.

The following is a summary of the main functions to be performed by the medication dose calculator 100. The medication dose calculator 100's display screen 204 allows the user to select a drug and enter various data parameters. Once all required data has been entered, it performs the necessary calculations to generate a dose to deliver value. While calculating the dose, the quantity of the selected drug ordered is checked against the recommended range limits for the particular drug selected from the drug database file. Appropriate warning messages are displayed depending on the result of the calculation and range checking. Information on the drug selected can also be viewed. The Conversions Screen allows the users to perform some basic conversions for mcg to/from mg, lb to/from kg and ml to/from liters for example. A surface area (square meters) formula is also provided. The Drip Rate Calculator allows the user to perform Drip Rate and Infusion Rate calculations. The Database Update allows the user to update the drug database file on the unit via the unit's PCMCIA slot. It is important to note that that Database Update can be accomplished by other means (e.g., Internet, Infrared, etc.) as explained above. The Basic Calculator provides a basic math calculator so the user can perform basic multiplication, division, addition and subtraction functions. The Warning/Event Log logs all warning events and other system events. The Usage & Warning Counters allow the user to view a total count of all warning messages issued and whether the warning was corrected or overridden. It also provides the user with the counts for the same warnings but over a set period of time (shift). The current shift and the three previous shifts can be viewed.

### INDUSTRIAL APPLICABILITY

The present invention is advantageously applicable in providing a medication dose calculator 100, which significantly improves the safety and efficacy of dispensing medicine by reducing the user's reliance on memory. Moreover, this medication dose calculator 100 simplifies the user algorithm and provides constraints and forcing functions that significantly reduce the reliance on vigilance and multiple data entry. This is also a more intuitive approach to calculating drug doses by providing a user algorithm that is located on the display screen 204. Furthermore, the drug information data stored in the database memory 252 is linked to the input data to elicit predetermined warnings and cautions when the input deviates from known dosage range information. This is in addition to providing an output for the recommend dosage of drugs.

This results in a device that significantly reduces the chance of medication error as well as reduces the amount of time needed to dispense drugs to patients by a medical professional. It also provides an efficient means for providing the caregivers at the point of care with the approved hospital formulary and protocol, by giving the pharmacist or other authorized personnel the ability to define the reference database that the medication dose and dosage will be compared against. Also by storing all of the transactional data, including data inputs, warnings and calculated dose, for future retrieval and use, it also provides a means for retrospectively reviewing what volume was administered in an attempt to improve patient outcomes and improve hospital protocols, quality control, record keeping and billing efficiency.

While it is envisioned that the medication dose calculator will predominately be used in hospitals by nurses at the point of care, paramedics, visiting nurses, veterinarians, as well as personnel in medical transport, (ambulance), satellite medical facilities, doctors offices, hospice centers and services, and military field deployments may also advantageously use the device.

Referring now to FIG. 8, the medication dose calculator 100 has a database memory 252 and transactional memory 260 for receiving, recording, and storing information. It is apparent to those skilled in the art that the database memory 252 and the transactional memory 260 may be one or more components and are not limited to two discrete components. It is also apparent to those skilled in the art that the computing mechanism 250 is configured to utilize hardware, firmware or software that provides coordination, communication, and interaction with the database memory 252, the user inputs, the outputs of the medication dose calculator 100, and the transactional memory 260.

The database memory 252 of the medication dose calculator 100 is configured to receive and store various types of information and data (hereinafter “database information”) to perform the functions previously described. For example, the database information on the database memory 252 includes medication specific information and protocols, which are used at the point of care to, among other things, calculate medication volumes and provide appropriate warnings and drug information. The downloading of database information to the database memory 252 from other sources will be explained in greater detail below. In the depicted embodiment, modification of the database information in the database memory 252 from the medication dose calculator 100 is precluded.

The database memory 252 may be on-board memory or on-board removable memory, such as but not limited to USB flash drives, CDs, DVDs, floppy drives, EPROM, etc., and other removable devices or technologies. In an alternative embodiment, the database memory 252 is remote from the medication dose calculator 100 and is accessible via various remote communication means, such as, but not limited to, WiFi, Internet, Infrared, etc. Due to possible communication interruptions, the operation or communication between the medication dose calculator 100 and the remote memory does not offer the reliability as provided by on-board memory or on-board removable memory, hence, a combination of onboard and remote memories is within the scope of the present invention.

The transactional memory 260 is configured to record and store all inputs and selections made by the user, all outputs displayed on the display screen 204, including without limitation warnings and doses, dates, times, locations, patient identifications, doctor or nurse identifications facilities and all downloads or updates along with the dates and versions of the updates made to the database memory 252 (hereinafter collectively “transactional information”). The transactional information in the transaction memory 260 is configured to be uploaded or transmitted to other applications as a transaction record, as will be explained in greater detail below.

The transactional memory 260 may be on-board memory or on-board removable memory, such as but not limited to USB flash drives, CDs, DVDs, floppy drives, written flash memory, etc., and other permanent or removable devices or technologies. In an alternative embodiment, the transactional memory 260 is remote from the medication dose calculator 100 and the transactional information is transmitted to the remote transactional memory 260 via various remote communication means, such as, but not limited to, WiFi, Internet, Infrared, etc. Due to possible communication interruptions, the operation or communication between the medication dose calculator 100 and the remote transactional memory does not offer the reliability as provided by on-board memory or on-board removable memory. In the depicted embodiment, modification of or access to the transactional information in the transactional memory 260 from the medication dose calculator 100 is precluded.

The medication dose calculator 100 may be a stand alone device or integrated into various IT, computer, or archive systems. The following description describes how the database information and transactional information are treated in various medical application, record or billing application systems. In the depicted embodiment, point of use access to the medical database is limited and access to the transactional database is controlled. Entry may be limited to those entering the appropriate password or biometrics. Point of use entry to the transaction record may not be allowed at all.

In the depicted embodiment, the database information in the medication dose calculator 100 will need to be kept current. For example, the database information contains drugs that may need to be added or deleted, and therapeutic protocols for drugs that may need to be modified. A database provider develops, controls, maintains, and provides updated database information to the purchaser of the medication dose calculator 100 as explained below. In addition, transactional information is created during the use of the medication dose calculator 100, and the transactional information is stored on the transactional memory 260. In the depicted embodiment, the transactional information maybe transferred to an external device for review, printing, storing, archiving, researching, reformatting of data, monitoring, data mining or entering into other applications.

The present invention includes various processes as will now be described. In a first embodiment of the present invention shown in FIG. 5 as a block diagram schematic that indicates the general electronic components and associated relationship for the medication dose calculator 100. The medication dose calculator 100 is generally indicated by numeral 300 and is a stand-alone system. The medication dose calculator 100 does not need to be in direct communication with an external interface or device during operation. In this embodiment, the database memory 252 is on-board memory.

The medication dose calculator 100 has a data transfer interface which in the depicted embodiment is a memory card interface 256 for receiving a memory card. The memory card, which contains previously downloaded or transmitted database information, is configured to transmit database information to the on-board database memory in the medication dose calculator 100. In an alternative embodiment, instead of downloading the database information from the memory card to the on-board memory, the computing mechanism 250 is configured to utilize, read, or access the database information directly from the inserted memory card, and the memory card serves as the database memory 252.

In the preferred embodiment, the medication dose calculator 100 may be used with a subscription for receiving periodic updates of the database information from a database provider. Database information may change as new pharmaceuticals become available, new warnings, generic equivalents, study results, availability data or hospital or pharmacy information may be added or removed.

The medication dose calculator 100 is initially provided with the database information. The database information may have been previously downloaded or transmitted to database memory 252. Optionally, a memory card containing the database information is provided with the medication dose calculator 100, and the database information on the memory card is downloaded to the database memory 252 of the medication dose calculator 100 by the purchaser.

Thereafter, the database provider provides updates of the database information, at certain intervals or as requested, to the purchaser of the medication dose calculator 100. Specifically, the database provider provides a memory card having the updated database information thereon to the purchaser. Thereafter, the purchaser downloads the updated database information to the on-board memory or database memory 252 of the medication dose calculator 100. Thus, the database memory 252 is kept current with up-to-date database information.

In a second embodiment of the present invention shown in FIG. 9 as a block diagram schematic that indicates the general electronic components and associated relationship for the medication dose calculator 100, the medication dose calculator 100 is generally indicated by numeral 300 and is a stand-alone system. The medication dose calculator 100 does not need to be in direct communication with an external interface or device during operation. In this embodiment, the database memory 252 is on-board memory, and the transactional memory 260 is on-board memory.

The medication dose calculator 100 has a memory card interface configured for receiving a memory card. The memory card, which contains previously downloaded or transmitted database information, is used to transmit database information to the on-board database memory in the medication dose calculator 100. In addition, a memory card is configured to receive the transactional information that is being recorded or received on the on-board transactional database 260 during use, and thereafter the memory card is configured to transmit the transactional information to an external device such as to a computer or archive system. In an alternative embodiment, instead of downloading the database information from the memory card to the on-board memory, the computing mechanism 250 is configured to utilize, read, or access the database information directly from the inserted memory card, and the memory card is configured as the database memory 252. In either embodiment as depicted, the database memory is ROM, although other memories, e.g., flash memory, may be used without departing from the scope of the present invention.

In addition, instead of transmitting the transactional information to the on-board transactional database 260, the medication dose calculator 100 may be configured to transmit transactional information directly to the memory card, and the memory card may be configured to include the transactional memory 260. The transactional information on the memory card may be uploaded or transmitted to an external system, such as a computer system. As described herein, the transactional information may be uploaded or transmitted to an external source by other communication means. Optionally, the purchaser may subscribe to a archival service in which the database provider stores or archives the purchaser's transactional information transmitted to the database provider via memory card or other communication means as described herein.

In this embodiment, the medication dose calculator 100 may be used with a subscription for receiving periodic updates of the database information from a database provider. The medication dose calculator 100 is initially provided with the database information. Preferably, the database information would have been previously downloaded or transmitted to database memory 252. Optionally, a memory card containing the database information is provided with the medication dose calculator 100, and the database information on the memory card is downloaded to the database memory 252 of the medication dose calculator 100 by the purchaser.

Thereafter, the database provider provides updates of the database information, at certain intervals or as requested, to the purchaser of the medication dose calculator 100. Specifically, the database provider provides a memory card having the updated database information thereon to the purchaser. Thereafter, the purchaser downloads the updated database information to the on-board memory or database memory 252 of the medication dose calculator 100. Thus, the database memory 252 is kept current with up-to-date database information. Communication port 254 is provided therefore.

In a third embodiment of the present invention shown in FIG. 10, the medication dose calculator 100 is a stand-alone system. The medication dose calculator 100 does not need to be in direct communication with an external interface or device during operation. In this embodiment, the database memory 252 is EPROM memory, and the transactional memory 260 is written flash memory.

In this embodiment, the medication dose calculator 100 is configured to send and receive data to and from the purchaser's or database provider's computer workstations 268. Specifically, the medication dose calculator 100 has a docking port 262 for communicating with the computer workstation 268 via a docking port 264 of a docking station 266. The workstation 268 is configured to receive database information from the database provider and, thereafter, configured to transmit the database information to the EPROM memory, which is the database memory 252, of the medication dose calculator 100 via the docking system 270. In addition, the docking system 270 is configured to transmit transactional information that was recorded or received on written flash memory during operation of the medication dose calculator 100 to the computer workstation 268. In an alternative embodiment, the docking system 270 is replaced with a telemetry cable connected to a cable input of the medication dose calculator 100 and a cable input of the computer workstation 268, thereby providing a communication means between the medication dose calculator 100 and the computer workstation 268 for transmission of database information, transactional information, setup information, software, etc.

In the depicted embodiment, the medication dose calculator 100 may be used with a subscription for receiving periodic updates of the database information, at certain intervals or as requested, from the database provider. The medication dose calculator 100 is initially provided with the database information. The database information may have been previously downloaded or transmitted to the database memory 252. Optionally, the purchaser may receive and install the initial database information in the same way they receive and install the updated database information, which is explained in detail below.

The database provider provides updates of the database information to the purchaser of the medication dose calculator 100. Specifically, the database provider has a Web Server 272 for providing a Web site via the Internet having current or updated database information that may be downloaded to the purchaser's or database provider's computer workstation 268. In an alternative embodiment, the undated or current database information is sent via e-mail attachment to the purchaser's or database provider's computer workstation 268. Thereafter, the purchaser downloads or transmits the updated database information to the EPROM memory of the medication dose calculator 100. Thus, the EPROM memory or database memory 252 is kept current with up-to-date database information.

In a fourth embodiment of the present invention shown in FIG. 11, the devices, systems, and processes described with regard to the first, second, or third embodiments may be utilized with a scanning system 274. The medication dose calculator 100 has a scanning unit 276 configured for communicating with a portable scanner 278. The portable scanner 278 is configured for scanning bar codes, RFID labels, electronic labels, or the like (hereinafter “information tag”) that contains various information needed to perform the previously described functions of the medication dose calculator 100. For example, a patient may wear a wristband, hospital gown, etc. having an information tag with the patient's information (e.g., the patient's name, gender, age, weight, body surface area, etc.) thereon. In another example, the container or packaging containing the medication to be administered to the patient has an information tag with information on the medication (e.g., type of drug, quantity, available quantity, etc.) thereon. In another example, a chart has an information tag thereon containing the patient's information, prescribed medication's information, and other relevant information for performing the functions of the medication dose calculator 100. In another example, the health care worker responsible for administering medication to a patient has an information tag on his/her uniform, wristband, badge, etc. with his/her information thereon so that the administering health care worker can be identified. The computing mechanism 250 utilizes this scanned tag information when necessary for the performing the various functions described above with regard to the medication dose calculator 100, thus, eliminating the need for having the user input the appropriate data. The advantages of this process are reduced errors and improved efficiency and speed. In the field, medical alert necklaces or bracelets may be scanned for data.

In a fifth embodiment of the present invention shown in FIG. 12, the device, system, and process described with regard to the third embodiment along with the scanning system 274 described in the fourth embodiment are incorporated with a wireless broadcast data transfer “WiFi” system 280 instead of the docking system 270 in this embodiment. The medication dose calculator 100 is a stand-alone system. The medication dose calculator 100 does not need to be in direct communication with an external interface or device during operation, but it may be. In this embodiment, the database memory 252 is EPROM memory, and the transactional memory 260 is written flash memory.

In this embodiment, the medication dose calculator 100 is configured to send and receive data to and from the purchaser's or database provider's computer workstations 268. Specifically, the medication dose calculator 100 has a WiFi port 282 for communicating with the computer workstation 268 via a WiFi port 284 of a WiFi station 286. The workstation 268 is configured to receive database information from the database provider and, thereafter, transmit the database information to the EPROM memory, which is the database memory 252, of the medication dose calculator 100 via the WiFi system 280. In addition, the WiFi system 280 is configured to transmit transactional information that was recorded or received on written flash memory during operation of the medication dose calculator 100 to the computer workstation 268.

In this embodiment, the medication dose calculator 100 may be used with a subscription for receiving periodic updates of the database information from the database provider. The medication dose calculator 100 is initially provided with the database information. The database information may have been previously downloaded or transmitted to the EPROM memory or database memory 252. Optionally, the purchaser may receive and install the initial database information in the same way they receive and install the updated database information, which is explained in detail below.

The database provider provides updates, at certain intervals or as requested, of the database information to the purchaser of the medication dose calculator 100. Specifically, the database provider has a Web Server 272 for providing a Web site via the Internet 268 having current or updated database information that may be downloaded to the computer workstation 268. In an alternative embodiment, the undated or current database information is sent via e-mail attachment to the computer workstation 268. Thereafter, the purchaser downloads or transmits the updated database information to the EPROM memory or database memory 252 of the medication dose calculator 100. Thus, the EPROM memory or database memory 252 is kept current with up-to-date database information.

In a sixth embodiment of the present invention shown in FIG. 13, any one of the previously described five embodiments is utilized along with a hospital Information Technology “IT” system 282. However, unlike the other five embodiments, in this embodiment, the hospital IT system 282 is configured to receive the database information from the database provider before download or transmission to the database memory 252 of the medication dose calculator 100. It is known in the industry that the hospitals or health care facilities or other providers (hereinafter “hospital”) do not always accept certain standard protocols for medications or the medications themselves. Thus, the hospital may modify the database information received from the database provider and maintain an in-house database. In this embodiment, the hospital reviews and may modify the database information from the database provider. Thereafter, the hospital's modified database information (hereinafter “in-house database” or “in-house database information”) is transmitted or downloaded to the database memory 252 of the medication dose calculator 100 via the computer workstation 268 by any one of the communication means described herein. Downloading proprietary hospital database updates may be secured by passwords or other secure communication techniques 294 so that medication dose calculator operations cannot be corrupted by database downloads from outside the parent hospital's system. Downloading may be by batch mode.

In addition, the hospital IT system 282 is configured to receive the transactional information from the transactional database 260 of the medication dose calculator 100 from the medication dose calculator 100, its removable memory, its transmitted memory, WiFi, Docking System, or indirectly from the intermediate computer workstation 268. Transfer of transaction records may also be secured with passwords or otherwise and may also be by batch mode or real time. Transactional information may also transfer by individual drug administration event record.

Before describing the structure, operation, and system of this embodiment and the seventh and eighth embodiments, it is important to understand the processing of the database information from the database provider to the hospital and then to the medication dose calculator 100. The database structure is as follows:

A database provider develops, maintains, and provides database information (hereinafter “Master Medication Database” or “MMD”) to the purchaser or hospital. The Master Medication Database contains all of the data and information that are necessary for the medication dose calculator 100 to function as described above and, for example, to operate as a volume calculator and medication information provider at the point of care. For example, the MMD contains, among other things, all data for a specific medication that is required by the medication dose calculator 100 to calculate a volume. This includes both the procedure needed for the medication (e.g., weight based or not), and the “normal” ranges for each medication contained in the database as suggested or recommended by the drug manufacturer, and for both inputs and outputs for the medication. In addition, the MMD may include any other drug specific information such as drug administration, side effects, contradictions, reversal agents as provided by the drug manufacturer, and such other information as is familiar from package inserts and/or the Physician's Desk Reference. As new drugs come to the market, as existing drugs are removed from the market, or as administration or medication protocols are change, it is important to update the MMD and ultimately the database information on the database memory 252 of the medication dose calculator 100 to provide the highest level of service and care. Additionally, other data that may add value can be included in the MMD by its provider.

The MMD may be used as the initial database that is downloaded or populated to the database memory 252 of the medication dose calculator 100. New versions of the MMDs may be used to update the medication databases in the medication dose calculators.

The MMD may be reviewed and possibly modified by the hospital, and if modified, the hospital creates the in-house database information used as the initial and updated database information that is loaded or transmitted to the database memory 252 of the medication dose calculator 100 instead of the MMD.

Hospitals may not always accept certain standard protocols for medications or the medications themselves. Thus, the hospital may modify the MMD received from the database provider and maintain an in-house database. The in-house database may be an identical version to the MMD if no changes are made to the MMD. If changes are made to the MMD, the hospital may maintain the MMD in addition to its in-house database for security and communication reasons. In an alterative embodiment, the hospital may assign the hospital's pharmacy the duties of modifying the MMD.

The business process that the hospital can use to modify the MMD to create the in-house database is shown in FIG. 14 as a block diagram schematic. In the depicted embodiment, as new or updated records become available from the database provider's Web Server 272, these records are transmitted over the Internet 292 or other communication means as described. These records are then processed 294 by the hospital or, if assigned, the pharmacist, to either be passed on to the in-house database 288 or to be discarded if there are no pertinent changes. If the record is to be passed on to the in-house database, it can further be checked to see if any modifications are necessary to match the hospital formulary or protocols. If a modification is required, it is made before being passed along to the in-house database, otherwise it is passed along without modification. If the hospital or pharmacist wishes to add an entirely new record, it may also do that at this point.

The in-house database is then downloaded or transmitted to the database memory 252 of the medication dose calculator 100. The database memory 252 may be on-board memory, memory embedded into another portable device (e.g., a patient bed or bed-side telemetry system), or remote memory as described herein. In the depicted embodiments of the present invention, the in-house database is downloaded onto the on-board database memory 252 in case of a power, IT, or communication outages.

In this sixth embodiment, each of the previously described five embodiments may be incorporated with the hospital IT system 282. The hospital IT system 282 is incorporated between the medication dose calculator 100 and the database provider's Web Server.

The hospital IT system 282 of the sixth embodiment is herein described with respect to the fifth embodiment; however, those skilled in the art will be able to understand the invention may be applied to the other embodiments after understanding the following. In this embodiment, the medication dose calculator 100 is a stand-alone system. The medication dose calculator 100 does not need to be in direct communication with an external interface or device during operation. In this embodiment, the database memory 252 is EPROM memory, and the transactional memory 260 is written flash memory.

The database provider has a Web Server 272 for providing a Web site having the MMD thereon that may be downloaded to the hospital IT database 288 of the hospital IT system 282 via the Internet 292. The hospital reviews and may modify the MMD as explained above creating and storing an in-house database on the hospital IT database 288. The hospital then sends the in-house database via a hospital LAN 290 to the computer workstation 268. The medication dose calculator 100 is configured to send and receive data to and from the computer workstations 268. Specifically, the medication dose calculator 100 has a WiFi port 282 for communicating with the computer workstation 268 via a WiFi port 284 of a WiFi station 286.

The computer workstation 268 receives the in-house database information from the hospital and, thereafter, transmits the in-house database to the EPROM memory, which is the database memory 252, of the medication dose calculator 100 via the WiFi system 280. In addition, the WiFi system 280 is configured to transmit transactional information that was recorded or received on written flash memory during operation of the medication dose calculator 100 to the computer workstation 268. Thereafter, the computer workstation 268 is configured to transmit or send the transmission information to the hospital IT database 288 of the hospital IT system 282.

In this embodiment, the medication dose calculator 100 may be used with subscriptions for receiving periodic updates of the MMD from the database provider. In the preferred embodiment, the medication dose calculator 100 is not initially provided with the MMD because the hospital reviews and possibly modifies the MMD, thereby creating the in-house database. In the preferred embodiment, the MMD is downloaded or transmitted to the hospital IT database 288 of the hospital IT system 282 and converted to the in-house database and then sent to computer workstation 268 and ultimately to the EPROM memory or database memory 252 of the medication dose calculator 100 as previously described.

If the hospital purchases the subscription for MMD updates, the database provider provides updated MMDs, at certain intervals or as requested, to the hospital. The database provider has a Web Server 272 for providing a Web site having the updated MMD thereon that may be downloaded to the hospital IT database 288 of the hospital IT system 282 via the Internet 292. The hospital reviews and may modify the updated MMD as explained above creating and storing an updated in-house database on the hospital IT database 288. The hospital then sends the updated in-house database via the hospital LAN 290 to the computer workstation 268. The computer workstation 268 is configured to then send the updated in-house database to the EPROM memory or database memory 252 of the medication dose calculator 100 via the WiFi system 280.

In the seventh embodiment of the present invention as shown in FIG. 13, the previously described sixth embodiment is applicable, however, the hospital does not modify the MMD into the in-house database. Thus, the MMD is downloaded or transmitted to the medication dose calculator 100 without being modified by the hospital. The hospital IT system 282 is incorporated between the medication dose calculator 100 and the database provider.

In this embodiment, the medication dose calculator 100 is a stand-alone system. The medication dose calculator 100 does not need to be in direct communication with an external interface or device during operation. In this embodiment, the database memory 252 is EPROM memory, and the transactional memory 260 is written flash memory.

The database provider has a Web Server 272 for providing a Web site having the MMD thereon that may be downloaded to the hospital IT database 288 of the hospital IT system 282 via the Internet 292. The hospital does not modify the MMD. The hospital sends the MMD via a hospital LAN 290 to the computer workstation 268. The medication dose calculator 100 is configured to send and receive data to and from the computer workstations 268. Specifically, the medication dose calculator 100 has a WiFi port 282 for communicating with the computer workstation 268 via a WiFi port 284 of a WiFi station 286. The computer workstation 268 is configured to transmit the MMD to the EPROM memory or database memory 252 of the medication dose calculator 100 via the WiFi system 280.

In addition, the WiFi system 280 is configured to transmit transactional information that was recorded or received on written flash memory during operation of the medication dose calculator 100 to the computer workstation 268. Thereafter, the computer workstation 268 is configured to transmit or send the transaction information to the hospital IT database 288 of the hospital IT system 282.

In this embodiment, the medication dose calculator 100 may be used with subscriptions for receiving periodic updates of the MMD from the database provider. In the preferred embodiment, the database memory 252 of the medication dose calculator 100 contains the MMD. In an alternative embodiment, the database provider has a Web Server 272 for providing a Web site having the MMD thereon that may be downloaded to the hospital IT database 288 of the hospital IT system 282 via the Internet 292. The hospital stores the MMD on the hospital IT database 288 of the hospital IP system 282. The hospital then sends the MMD via the hospital LAN 290 to the computer workstation 268. The computer workstation 268 is configured to send the MMD to the EPROM memory or database memory 252 of the medication dose calculator 100 via the WiFi system 280.

If the hospital purchases the subscription for MMD updates, the database provider provides updated MMDs, at certain intervals or as requested, to the hospital. The database provider has a Web Server 272 for providing a Web site having the updated MMD thereon that may be downloaded to the hospital IT database 288 of the hospital IT system 282 via the Internet 292. The hospital stores the MMD on the hospital IT database 288. The hospital then sends the MMD via the hospital LAN 290 to the computer workstation 268. The computer workstation 268 is configured to then send the MMD to the EPROM memory or database memory 252 of the medication dose calculator 100 via the WiFi system 280.

In the eighth embodiment of the present invention as shown in FIGS. 12 and 13, the previously described sixth and seventh embodiments are applicable to the present embodiment; however, the medication dose calculator 100 is replaced by a PDA or other portable electronic device that is programmed with software for performing all of the functions previously described with respect to the medication dose calculator 100. Portability in this application is not limited. It may include for example attachment to or incorporation with any movable equipment, e.g., tablet computers, RFID or bar code scanners, beds or stretchers, is within the scope of the invention.

In another alternative embodiment, the workstation computer 268 and the connecting means to the medication dose calculator 100 are owned and controlled by the database provider.

It should be noted that the communication means described above with regard to the previous eight embodiments are not meant to be limiting and substitutions with other technologies may be made. In addition to these eight embodiments, the transfer of either the transactional record or the database information or MMD between the various devices discussed above may be performed with other devices or systems, such as removable memory cards, flash memory cards, CDs, DVDs, WiFi technology, LAN technology, the Internet, the communication means used by the hospital IT system 282, a docking station, telemetry cable, docking systems configured for use with wired (e.g., Ethernet or TCP/IP protocol) or a wireless link (e.g., WiFi, Bluetooth, etc.) and any other means described herein or equivalent thereto or known other known communication means.

The invention in its broader aspects is not limited to the specific steps, systems, or apparatuses shown and described, but departures may be made therefrom without deviating from the principles of the invention and without sacrificing its chief advantages. Other aspects, objects and advantages of the present invention can be obtained from a study of the drawings and the disclosure.

What is claimed is:

1. A medication calculator for calculating a medication dose and for comparing an ordered medication dosage with a known medication dosage range, said medication calculator comprising:
a user interface, said user interface being configured to receive a patient data input and an ordered medication dosage input;
said user interface being further configured to display to a human user a dose calculation or a warning message;
a medication database, said medication database being operatively connected to said user interface and said medication database including a medication dosage range associated with each of a plurality of medications and said medication database including at least one warning, said at least one warning being associated with at least one of said plurality of medications;
a processor, said processor being in operative communication with said medication database and with said user interface, said processor being configured to calculate a medication dose in response to a patient data input and an ordered medication dosage input and
said processor signaling said user interface to display said warning when the ordered medication dosage is outside said medication dosage range and said processor signaling said user interface to display the medication dose when the ordered medication dosage is within said medication dosage range.

2. The apparatus of claim 1 further including a transactional record stored in a first memory, said first memory being operatively connected to said processor, and said transactional record being configured to store at least one of the patient data input, the ordered medication dosage, said medication dose, a unit of measure, and said warning.

3. The apparatus of claim 1 wherein said patient data input includes at least one of a patient weight, a patient surface area and a patient age as a child or as an adult.

4. The apparatus of claim 1 wherein said processor is further configured to solicit additional data input via said user interface when said medication dose cannot be communicated.

5. The apparatus of claim 1 wherein said dose calculation includes at least one of a patient body weight or a patient body surface area.

6. The apparatus of claim 1 wherein said warning warns that an ordered medication dosage is outside said medication dosage range.

7. The apparatus of claim 1 wherein said warning is independent of said medication dosage range.

8. The apparatus of claim 1 wherein said medication database may be updated through communication with a computer network.

9. The apparatus of claim 8 wherein said communication with a computer network is selected from the group consisting of: the Internet, a web site, an e-mail, a limited area network, a wide area network, a memory card, a PCMCIA card, a docking station, a telemetry cable, an infrared port, a radio frequency port and a wireless data transfer port.

10. The apparatus of claim 8 wherein said updating is by batch mode.

11. The apparatus of claim 1 wherein said medication database includes data configured according to a unique hospital configuration, said unique hospital configuration being provided by an individual hospital associated with said medication calculator.

12. The apparatus of claim 1 wherein said medication dose is recalculated upon receipt of a new patient data input.

13. The apparatus of claim 1 wherein said medication dose includes a dosage over time.

14. The apparatus of claim 1 wherein said patient data input is by scanning.

15. The apparatus of claim 14 wherein said scanning is of a bar code.

16. The apparatus of claim 15 wherein said scanning is of a radio frequency identification chip.

17. The apparatus of claim 1 wherein said medication dose is calculated according to the equation: Dose=(Total Amount Ordered/Amount Available)*Volume.

18. The apparatus of claim 1 wherein said Total Amount Ordered can be any one of: an Amount Ordered, an Amount Ordered*(Body Weight or Body Area of Patient) or an Amount Ordered*((Body Weight in kg or Body Area in M²)/Time).

19. The apparatus of claim 1 wherein a medication dose may be calculated when a warning is given for an ordered medication dosage being outside a medication dosage range.

20. The apparatus of claim 1 wherein said processor is further configured to convert units for a medication dose.

21. The apparatus of claim 1 wherein said processor calculates a single dose.

22. The apparatus of claim 1 wherein said processor calculates a dose to be administered per unit of time.

23. The apparatus of claim 1 wherein said processor signals a display of said warning when said warning is associated in said medication database with a calculation of an ordered medication dosage per at least one of a patient weight or a patient surface area.

24. The apparatus of claim 2 wherein said transactional record is further configured to store every patient data input, every ordered medication dosage, every medication dose, every unit of measure applied to said medication dose and every warning.

25. The apparatus of claim 2 wherein said transactional record is further configured to store all decimal entries in the digital display screen; all individual drug usages; all outside of range warning occurrences; all outside of range warning occurrences that were overridden by the user; all outside of range warning occurrences that were corrected by the user; all no range check warning occurrences; all no range check warning occurrences that were overridden by the user; all no range check warning occurrences that were corrected by the user; all conversion error occurrences; and all conversion error occurrences that were corrected by the user.
